(19) United States
(12) Patent Application Publication
(10) Pub. No.: US 2022/0316180 A1
(43) Pub. Date: Oct. 6, 2022

(54) REMOTE DRIVING DEVICE AND OPERATION MECHANISM FOR WORK MACHINE

(71) Applicant: KOBELCO CONSTRUCTION MACHINERY CO., LTD., Hiroshima (JP)

(72) Inventor: Hitoshi SASAKI, TOKYO (JP)

(21) Appl. No.: 17/699,340

(22) Filed: Mar. 21, 2022

(30) Foreign Application Priority Data
Apr. 5, 2021 (JP) 2021-064475
Jun. 11, 2021 (JP) 2021-098082

(51) Int. Cl. E02F 9/20

(52) U.S. Cl. CPC E02F 9/2004; E02F 9/202; E02F 9/205

(57) ABSTRACT

A remote driving device (100) includes an operation lever (1) to be operated based on an operation command signal, and a first operation mechanism (30) which tilts the operation lever (1). The first operation mechanism (30) includes a first actuator (31) which generates a driving force to tilt the operation lever (1) based on the operation command signal, a first transmission device (41) which transmits the driving force of the first actuator (31), a first detector (61) which detects a tilting amount of the operation lever (1), and a first drive shaft (51). On the first drive shaft (51), a first rotation output part (52) is provided, and the first drive shaft rotates with the tilting of the operation lever (1). The first detector (61) detects the tilting amount of the operation lever (1) via the first rotation output part (52).

### BACKGROUND OF THE INVENTION

### Field of the Invention

The present invention relates to a remote driving device to remotely drive a vehicle based on an operation command signal. Also, the present invention relates to an operation mechanism for a work machine, which tilts, in one direction based on an operation command, an operation lever to control an operation of the work machine in response to being tilted in the one direction.

### Description of the Related Art

Heretofore, a remote driving device has been known which remotely drives an operation lever of a vehicle in response to an operation command signal from outside the vehicle, as disclosed in Japanese Patent Laid-Open No. 11-50493. The remote driving device described in Japanese Patent Laid-Open No. 11-50493 is a remote driving device which can be attached to a vehicle without any modification on the vehicle and comprises a control link mechanism which is operated by an operator at hand, and an operation link mechanism which is attached to the operation lever of the vehicle to remotely drive the operation lever. The operation lever of the vehicle is remotely driven in response to the operation of the control link mechanism operated by the operator. An angle detector, such as a potentiometer, may be provided in one end of each shaft of the operation link mechanism, and this angle detector may detect an actual operation amount of the operation lever of the vehicle, to confirm whether the operation lever works as remotely operated.

Also, heretofore, an operation mechanism has been known which indirectly operates an operation lever directly operable by an operator seated on a seat, based on an operation command transmitted from outside a work machine, to execute remote control of the work machine (see Japanese Patent Laid-Open No. 2017-172174, for example). The operation mechanism described in Japanese Patent Laid-Open No. 2017-172174 comprises an actuator which works based on an operation command for tilting the operation lever, and a pair of guide members which guide the operation lever in a tilting direction.

In such a remote driving device as described in Japanese Patent Laid-Open No. 11-50493, the operation link mechanism is retrofitted in the operation lever of the vehicle, and hence with a combination of the vehicle and the operation link mechanism, the operation link mechanism might interfere with a seat, an operation device or the like which is placed in the vehicle. Furthermore, in a case where an actual driving amount of the operation lever by a remote operation is to be detected, since the angle detector is attached to one end of a rotary shaft of the operation link mechanism, a length of the operation link mechanism in a rotary shaft direction increases by a thickness of the angle detector, which makes it difficult to make a circumference of the operation lever compact.

Further, around the operation lever, many components are arranged, and hence there is a need to design the circumference as compact as possible.

In the operation mechanism described in Patent Laid-Open No. 2017-172174, the pair of guide members are arranged to sandwich the operation lever therebetween, and each guide member is assembled to a support member supporting the guide member. However, when arranging the pair of guide members as close to each other as possible to design the circumference of the operation lever compact, the operation lever might interfere with the guide members. Also, when an interval between the pair of guide members is increased to prevent the operation lever from being interfered with the guide members, responsiveness of the operation lever might deteriorate.

To solve the above problems, the present invention aims to provide a remote driving device which can be easily retrofitted in an operation lever, and which comprises an operation amount detection device, to suppress an external dimension.

The present invention also aims to provide an operation mechanism for a work machine, in which it is possible to hold an appropriate clearance for designing a compact periphery around the operation lever and avoiding interference of the operation lever with guide members.

### SUMMARY OF THE INVENTION

A remote driving device according to the present invention is a remote driving device which manipulates an operation mechanism for a work machine based on an operation command signal, the remote driving device comprising: an operation lever to control an operation amount of the work machine depending on a tilting angle and a tilting direction, and a first operation mechanism which tilts the operation lever in a first direction, wherein the first operation mechanism comprises a first actuator which generates a driving force to tilt the operation lever in the first direction via a first-direction guide member based on the operation command signal, a first transmission device which transmits the driving force generated by the first actuator to the first-direction guide member, a first detector which detects a tilting amount of the operation lever to the first direction, and a first drive shaft which rotates with the tilting of the operation lever to the first direction, and on the first drive shaft, a first rotation output part which transmits the rotation of the first drive shaft to the first detector is disposed, and the first detector detects the tilting amount of the operation lever to the first direction via the first rotation output part.

According to the remote driving device of the present invention, the detector can detect the tilting amount via the rotation output part disposed on the first drive shaft of the operation lever. Therefore, the rotation output part is disposed on the drive shaft, but a space for a wire and the like connected to the first detector does not have to be reserved on the drive shaft. Consequently, the space to be reserved reduces as compared with a case where the first detector is disposed on the drive shaft, and hence an external dimension of the remote driving device in a drive shaft direction can be suppressed.

The remote driving device according to the present invention preferably has a configuration where a length of the first rotation output part in a direction of the first drive shaft is shorter than a length of the first rotation output part in the first drive shaft direction in a case where the first detector is disposed on the first drive shaft.

In this case, the rotation output part disposed on the first drive shaft of the operation lever is disposed with a smaller thickness than in a case where the first detector is disposed. Therefore, the space to be reserved reduces as compared with the case where the first detector is disposed on the drive shaft, and hence the external dimension of the remote driving device in the drive shaft direction can be suppressed.

In the remote driving device according to the present invention, it is preferable that the first-direction guide member is pivotally supported so as to rotatable about the first drive shaft.

In this case, the rotation output part transmits the rotation of the drive shaft of the first-direction guide member. Therefore, without providing any sensors that directly detects inclination of the operation lever, the tilting amount of the operation lever can be detected from a structure retrofitted in the operation lever.

In the remote driving device according to the present invention, it is preferable that the first rotation output part includes a first transmission part extended from the first drive shaft toward the first detector, the first transmission part has an external shape with a first teeth portion formed on a circular arc around the first drive shaft, and the first detector includes a first rotation part to be rotated by the first teeth portion, and detects the rotation of the first rotation part to detect the tilting amount of the operation lever to the first direction.

In this case, the first detector is disposed in a direction intersecting the first drive shaft. Therefore, the external dimension of the remote driving device in the drive shaft direction can be suppressed.

In the remote driving device according to the present invention, it is preferable that the first actuator includes a first rotary shaft which generates a driving force to tilt the operation lever in a first direction, and the first rotary shaft is disposed parallel to and offset from the first drive shaft.

In this case, the first rotary shaft is disposed at a position parallel to and offset from the first drive shaft. Therefore, the device can be easily retrofitted in a limited space around the operation lever.

It is preferable that the remote driving device according to the present invention includes a second operation mechanism which tilts the operation lever in a second direction that is a direction intersecting the first direction, the second operation mechanism comprises a second-direction guide member which tilts the operation lever in the second direction, a second actuator which generates a driving force to tilt the operation lever via the second-direction guide member based on the operation command signal, a second transmission device which transmits the driving force generated by the second actuator to the second-direction guide member, a second detector which detects a tilting amount of the operation lever to the second direction, and a second drive shaft which rotates with the tilting of the operation lever to the second direction, and on the second drive shaft, a second rotation output part which transmits the rotation of the second drive shaft is disposed, and the second detector detects the tilting amount of the operation lever to the second direction via the second rotation output part.

In this case, to tilt the operation lever in a plurality of directions, even when a plurality of guide members which respectively guide the operation lever in different directions, and a plurality of actuators corresponding to the respective guide members are provided, the space to be reserved on each drive shaft reduces, and hence the external dimension of the remote driving device can be suppressed.

In the remote driving device according to the present invention, it is preferable that at least parts of the first transmission device and the second transmission device overlap, in a directional view perpendicular to a plane including the first drive shaft and the second drive shaft, or a directional view parallel to a straight line connecting the first drive shaft and the second drive shaft at the shortest distance.

In this case, at least parts of the first transmission device and the second transmission device are three-dimensionally overlapped in an up-down direction, and the devices can be easily retrofitted in the limited space around the operation lever of the vehicle.

In the remote driving device according to the present invention, it is preferable that a first connection part of the first transmission device to which the first actuator is connected and a second connection part of the second transmission device to which the second actuator is connected are both included in one of four regions defined by a vertically extending virtual plane including the first drive shaft intersecting a vertically extending virtual plane including the second drive shaft.

In this case, the remote driving device can be received relative to the operation lever in a limited region range in one of vehicle front and rear directions and one of vehicle left and right directions, and hence the remote driving device can be easily retrofitted in the limited space around the operation lever.

Furthermore, an operation mechanism for a work machine of the present invention is an operation mechanism for a work machine, which tilts, in a first direction based on an operation command, an operation lever to control an operation of the work machine in response to being tilted in the first direction, the operation mechanism comprising: an actuator to tilt the operation lever in the first direction based on the operation command, a pair of guide members extending along the first direction from one end toward the other end to guide the operation lever, the guide members being provided facing each other to sandwich the operation lever between the guide members in a second direction perpendicular to the first direction, a pair of support members to which the pair of guide members are respectively attached in the one end and the other end, respectively, and a positioning part formed in the pair of support members, to position at least one of the one end and the other end of each of the pair of guide members in the second direction.

According to the operation mechanism for the work machine of the present invention, when attaching the opposite ends of each of the pair of guide members to the pair of support members, respectively, it is possible to eliminate or reduce a positional shift in the second direction caused by a mechanical fixing mechanism and a slight positional shift in the second direction during an attaching work. This makes it possible to hold an appropriate clearance for avoiding interference of the operation lever with the guide members. Also, since each guide member is formed in the positioning part, a member to position the guide member does not have to be provided separately, so that compact design is possible.

In the operation mechanism for the work machine according to the present invention, it is preferable that the positioning part is constituted of one or both of a concave portion and a convex portion formed in each support member in a third direction perpendicular to the first direction and the second direction and engages with at least a part of at least one of the one end and the other end of each of the pair of guide members.

In this case, the one end and the other end of each of the pair of guide members can be positioned in the second direction by the concave and convex portions engaging with the support members, which makes it possible to facilitate the positioning.

Also, in the operation mechanism for the work machine of the present invention, it is preferable to further comprise a bracket which covers at least a part of an outer circumference of the operation lever, the bracket being sandwiched between the pair of guide members.

A gap between the operation lever and the pair of guide members varies with the operation lever, and in this case, if the operation lever differs, it is possible to make a constant gap between the bracket and the pair of guide members by attaching the bracket which covers at least a part of the outer circumference of the operation lever. This can achieve a constant operation with the pair of guide members regardless of a difference in the operation lever.

A work machine of the present invention is characterized by comprising the above operation mechanism for the work machine.

### BRIEF DESCRIPTION OF THE DRAWINGS

FIG. 1 is a perspective view showing a driving seat of a work machine to which a remote driving device of the present invention is attached;

FIG. 2 is a top view of FIG. 1;

FIG. 3 is a perspective view of the remote driving device on a right side of FIG. 1 seen from front right;

FIG. 4 is a perspective view showing a state where an operation lever and peripheral members around the operation lever are removed from FIG. 3;

FIG. 5 is a plan view of the remote driving device of FIG. 3;

FIG. 6 is a left side view of the remote driving device on the right side of FIG. 1;

FIG. 7 is a front view of the remote driving device on the right side of FIG. 1;

FIG. 8 is a right side view of the remote driving device on a left side of FIG. 1;

FIG. 9 is a front view of the remote driving device on the left side of FIG. 1;

FIG. 10 is a cross-sectional view showing cross section A-A of FIG. 5;

FIG. 11 is a cross-sectional view showing cross section B-B of FIG. 5;

FIG. 12 is a cross-sectional view showing cross section C-C of FIG. 5;

FIG. 13 is a cross-sectional view showing cross section D-D of FIG. 5;

FIG. 14 is a schematic view showing an entire configuration of a remote operation system for a work machine according to an embodiment;

FIG. 15 is a schematic view showing a schematic configuration of a remote operation apparatus of the remote operation system of FIG. 14;

FIG. 16 is a block diagram showing a configuration concerning control of the remote operation system of FIG. 14;

FIG. 17 is a perspective view showing a configuration around a seat of the work machine of FIG. 14;

FIG. 18 is a perspective view showing an operation mechanism of the work machine of FIG. 14;

FIG. 19 is a plan view showing the operation mechanism of the work machine of FIG. 14;

FIGS. 20A and 20B are views showing a positioning mechanism according to a first embodiment of the remote operation system for the work machine, FIG. 20A is a front view, and FIG. 20B is a plan view;

FIGS. 21A and 20B are views showing a positioning mechanism according to a second embodiment of the remote operation system for the work machine, FIG. 21A is a front view, and FIG. 21B is a plan view; and

FIG. 22 is a perspective view showing an operation mechanism for a work machine according to a third embodiment of the remote operation system for the work machine.

### DETAILED DESCRIPTION OF THE PREFERRED EMBODIMENTS

Hereinafter, description will be made as to remote driving devices 100 and 300 according to embodiments with reference to the drawings.

The remote driving devices 100 and 300 are devices attached to a control device of a vehicle, to remotely operate the vehicle in response to an operation command signal. A remote operation apparatus which remotely operates the vehicle comprises a remote operation lever similar to an actual machine operation lever, and the operation command signal corresponding to an operation of the remote operation lever is transmitted from the remote operation apparatus via network to the remote driving devices 100 and 300, to remotely operate the vehicle. The vehicle to which the remote driving devices 100 and 300 are attached is, for example, a hydraulic excavator. The remote driving devices 100 and 300 may be attached to a mobile crane, a dump truck, a passenger car, a bus, a truck and the like, in addition to the hydraulic excavator. The vehicle to which the remote driving devices 100 and 300 are attached can be remotely manipulated without any operator boarding or can be directly manipulated by the operator boarding. The remote driving devices 100 and 300 can be configured to be retrofitted in the control device of the vehicle.

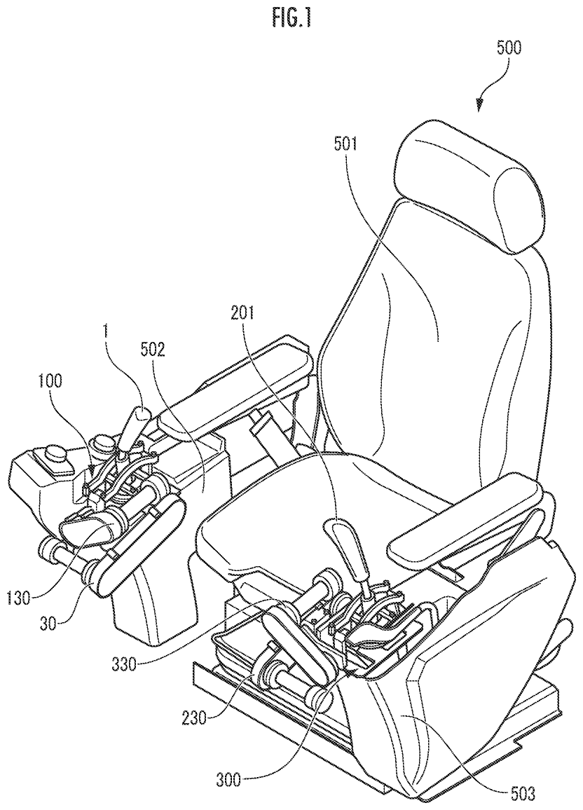

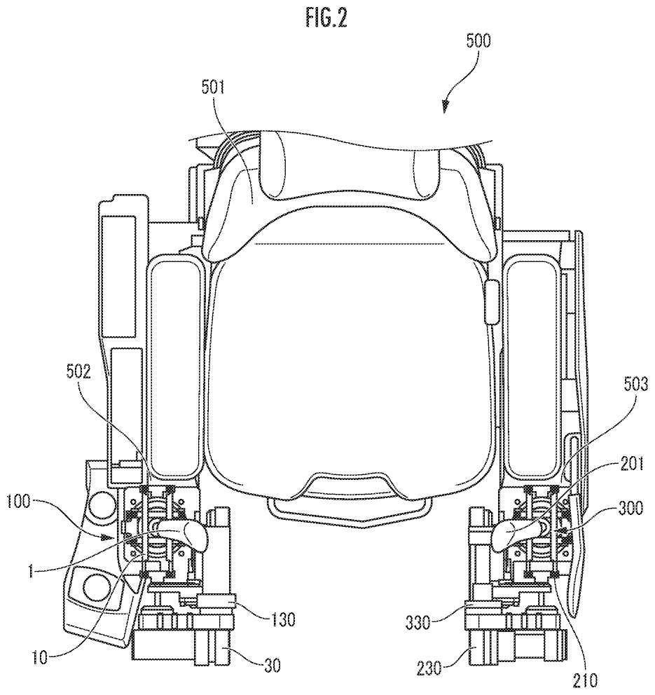

Description will be made as to operation levers 1 and 201 to be remotely operated with reference to FIGS. 1 and 2. FIGS. 1 and 2 are a perspective view and a top view of a drivers cab 500 of a work machine, respectively. The right operation lever 1 and the left operation lever 201 are arranged above console boxes 502 and 503 arranged on right and left of a seat 501 on which the operator sits, respectively, inside the drivers cab 500 of the work machine. A wall of the drivers cab is disposed on a side of the right console box 502 opposite to the seat 501. In a case of the hydraulic excavator, the operation levers 1 and 201 are tilted to manipulate swing angles of a boom and an arm, for example. In a case where the vehicle comprises a plurality of operation levers 1 and 201, the remote driving devices 100 and 300 can be attached to the operation levers 1 and 201, respectively.

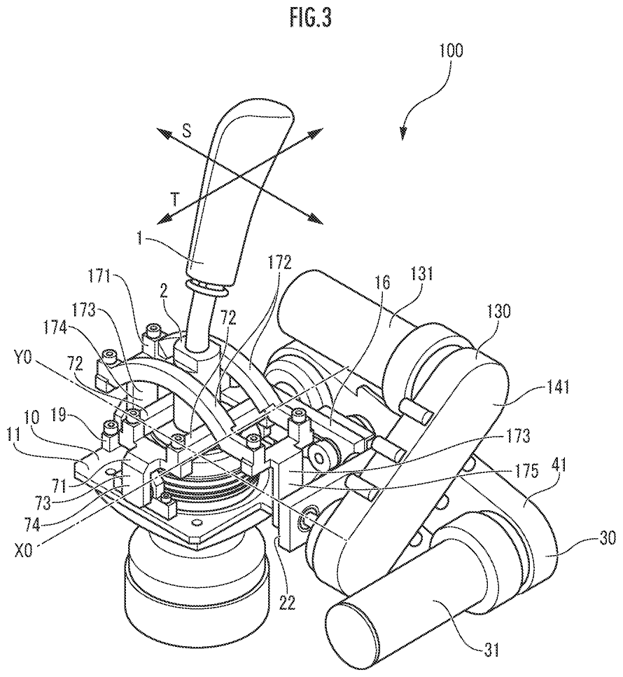

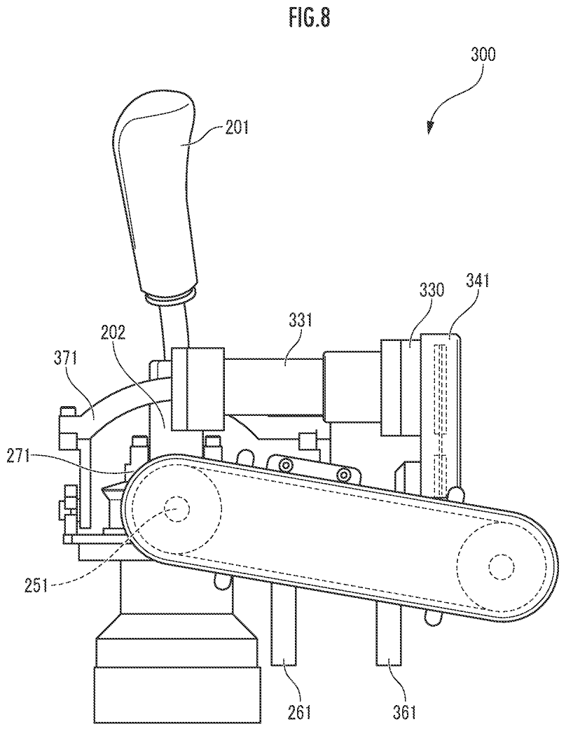

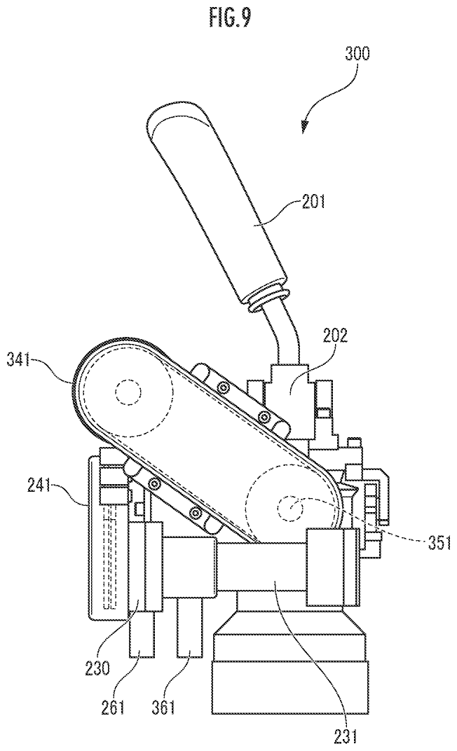

Hereinafter, description will be made as to a case of attaching one operation lever 1 that is tiltable in each of two intersecting directions. Note that the remote driving device may be configured to control in not both of two operation directions but one of the directions, for example, a first or second direction only. Additionally, FIGS. 3 to 7 and FIGS. 10 to 13 show a peripheral part of the right operation lever 1 disposed on the right of the seat, and FIGS. 8 and 9 show a peripheral part of the left operation lever 201 disposed on the left of the seat. The following description focuses on the right remote driving device 100.

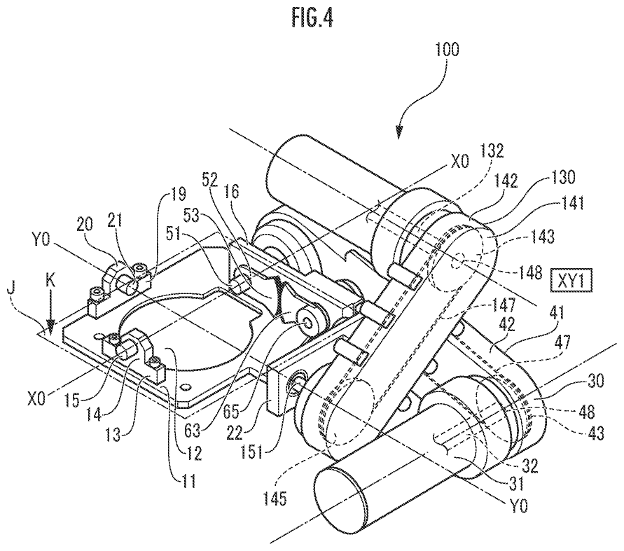

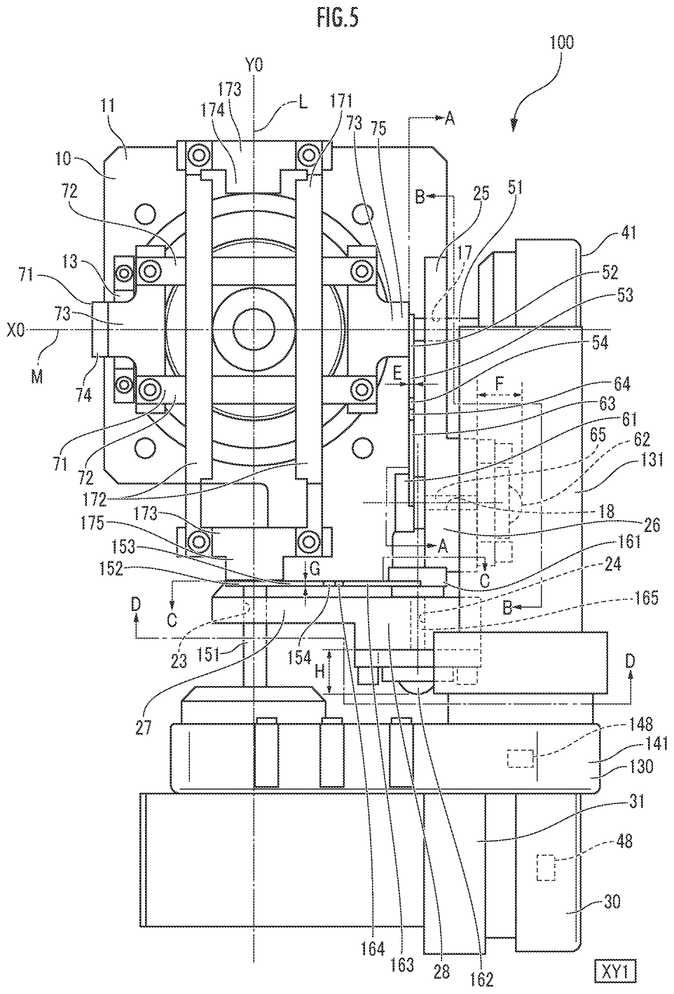

The remote driving device 100 will be described with reference to FIGS. 3 to 5. Note that to make it easier to understand, FIG. 4 does not show the operation lever 1 or any peripheral member around the operation lever 1, and FIG. 5 does not show the operation lever 1.

The remote driving device 100 includes a first operation mechanism 30, a second operation mechanism 130, a support device 10, and the operation lever 1. The first operation mechanism 30 and the second operation mechanism 130 are mechanisms which tilt the operation lever 1 in each of an S-direction (front-rear direction in the drivers cab) that is a first direction, and a T-direction (left-right direction in the drivers cab) that is a second direction.

The first operation mechanism 30 and the second operation mechanism 130 include a first drive shaft 51, and a second drive shaft 151. The first operation mechanism 30 and the second operation mechanism 130 tilt the operation lever 1 in the first direction (S-direction in FIG. 3) and the second direction (T-direction in FIG. 3) with a central axis X0 of the first drive shaft 51 and a central axis Y0 of the second drive shaft 151 as centers of rotation. The central axis X0 of the first drive shaft 51 and the central axis Y0 of the second drive shaft 151 are arranged orthogonally on the same plane. Note that the central axis X0 and the central axis Y0 do not have to be on the same plane and may be arranged to shift from each other in an up-down direction.

The support device 10 will be described with reference to FIGS. 4 and 5. The support device 10 is a device which rotatably holds a member transmitting a driving force from the first operation mechanism 30 and the second operation mechanism 130 to the operation lever 1. The support device 10 includes a base plate 11, which is a plate-shaped member formed in a substantially quadrangular shape and including a central hole 12, as well as a first support member 13, a second support member 16, a third support member 19, and a fourth support member 22 which are arranged adjacent to four sides of the substantially quadrangular shape of the base plate 11, respectively.

The base plate 11 is fixed near an operation lever base end 2 in a state where the operation lever 1 is passed through the central hole 12. In a top surface of the base plate 11, the first support member 13 and the second support member 16 are arranged adjacent to two opposite sides of the substantially quadrangular shape of the base plate 11, and the third support member 19 and the fourth support member 22 are arranged adjacent to other two opposite sides of the substantially quadrangular shape of the base plate 11. The first support member 13 and the second support member 16 are arranged spaced away from each other in a direction of the central axis X0, and pivotally support an after-mentioned first-direction guide member 71 in a rotatable manner about. Also, the third support member 19 and the fourth support member 22 are arranged spaced away from each other in a direction of the central axis Y0, and pivotally support an after-mentioned second-direction guide member 171 in a rotatable manner about.

The first support member 13 and the third support member 19 are plate-shaped members having a substantially inverted T-shape with convex parts 14 and 20 formed in central parts of the members, respectively. Both the members are arranged on the top surface of the base plate 11 with the convex parts 14 and 20 on upsides, respectively. The first support member 13 and the third support member 19 are bolted to the base plate 11 at the respective opposite ends. Alternatively, the members may be fixed to the base plate 11 at the respective opposite ends by welding. On an outer surface of the convex part 14 of the first support member 13 and an inner surface of the convex part 20 of the third support member 19, cylindrical fixed shafts 15 and 21 are provided, respectively.

As shown in FIG. 5, the second support member 16 and the fourth support member 22 are plate-shaped members having L-shaped cross sections with two thicknesses of thin plate parts 25 and 27, and thick plate parts 26 and 28. The second support member 16 includes the thin plate part 25 and the thick plate part 26. The fourth support member 22 includes the thin plate part 27 and the thick plate part 28. A shaft hole 17 is provided in the thin plate part 25 of the second support member 16, and a shaft hole 18 is provided in the thick plate part 26. Also, a shaft hole 23 is provided in the thin plate part 27 of the fourth support member 22, and a shaft hole 24 is provided in the thick plate part 28. The second support member 16 and the fourth support member 22 are fixed to the base plate 11 with unshown bolts in a state where respective side surfaces constituted of the thin plate parts 25 and 27 and the thick plate parts 26 and 28, are in contact with the base plate 11. Alternatively, both the members may be fixed to the base plate 11 by welding.

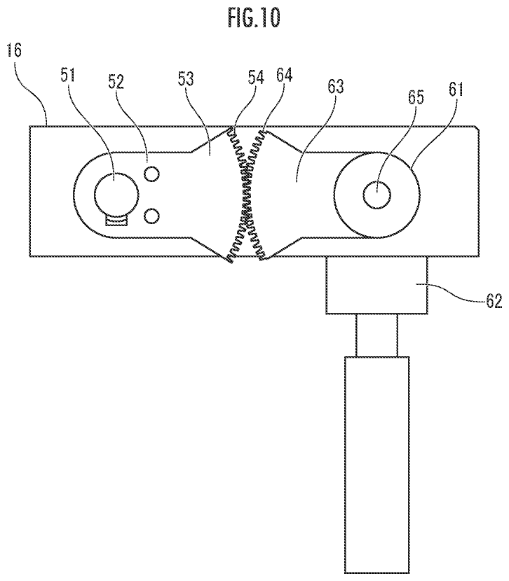

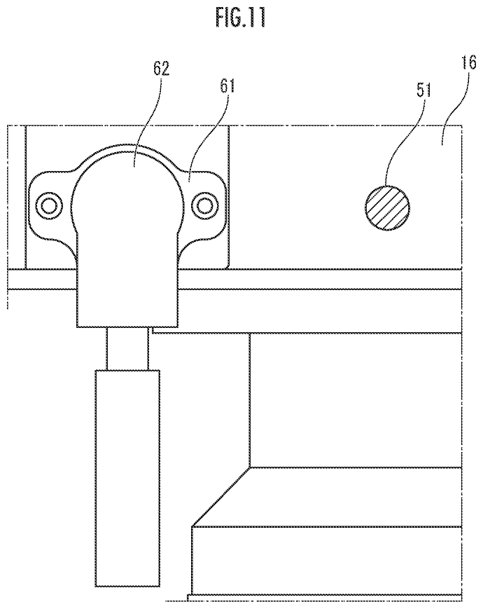

Referring to FIGS. 4, 5, 10 and 11, members provided in the second support member 16 are described. The first operation mechanism 30 included in the remote driving device 100 includes a first actuator 31 which generates the driving force, a first transmission device 41 which transmits the driving force of the first actuator 31, a first drive shaft 51, a first detector 61, and the first-direction guide member 71. The first drive shaft 51 is disposed on one side surface of the second support member 16, and the first detector 61 is disposed on the other side surface. FIG. 10 shows cross section A-A of FIG. 5 and shows the second support member 16 seen from an operation lever 1 side. Also, FIG. 11 shows cross section B-B of FIG. 5 and shows a surface of the second support member 16 opposite to FIG. 10.

The first drive shaft 51 is a cylindrical rotary shaft and includes a first rotation output part 52 which outputs rotation of the first drive shaft 51 to between opposite ends of the first drive shaft 51. The first rotation output part 52 includes a first transmission part 53 formed to extend toward the first detector 61. The first transmission part 53 is a substantially fan-shaped member including a circular arc portion of a disk having a constant radius and is provided in the first rotation output part 52. The first transmission part 53 is a member in which a first teeth portion 54 is formed on a circular arc around the central axis X0 as a center of the circular arc. The first drive shaft 51 is inserted into the shaft hole 17 provided in the second support member as shown in FIG. 5 and is therefore rotatably held.

The first detector 61 is a member to detect a rotation angle of the first drive shaft 51. The first detector 61 includes a first detector body 62, a first rotation part 63 to which rotation is transmitted from the first transmission part 53, and a coupling shaft 65 coupling the first rotation part 63 and the first detector body 62. The first detector body 62 is, for example, a potentiometer. The first rotation part 63 is a member including a substantially fan-shaped part having a circular arc portion and is fixed to the coupling shaft 65 by fitting the coupling shaft 65 into a hole formed in a substantially oval portion continuous with the circular arc portion. The first rotation part 63 includes a second teeth portion 64 formed on a circular arc around a central axis of the coupling shaft 65 as a circular arc center.

The coupling shaft 65 is inserted into the shaft hole 18 provided in the second support member 16 as shown in FIG. 5, and rotatably held relative to the second support member 16. The first rotation part 63 is coupled to an end of the coupling shaft 65 on the same side as in the first transmission part 53. Also, the first detector body 62 is coupled to an end of the coupling shaft 65 opposite to the first rotation part 63. The first teeth portion 54 of the first transmission part 53 and the second teeth portion 64 of the first rotation part 63 are arranged in a state of being meshed with each other. Therefore, the rotation of the first drive shaft 51 is transmitted to the first detector body 62 via the first transmission part 53, the first rotation part 63, and the coupling shaft 65. Specifically, the first detector 61 includes the first rotation part 63 to be rotated by the first teeth portion 54 and detects the rotation of the first rotation part 63, to detect a tilting amount of the operation lever 1 to the first direction (S-direction).

Referring to FIGS. 4, 5, 12, and 13, members provided in the fourth support member 22 are described. The second drive shaft 151 is disposed on one end side of the fourth support member 22, and a second detector 161 is disposed on the other end side. The second drive shaft 151 and the second detector 161 have the same functions as in the first drive shaft 51 and the first detector 61, respectively. However, arrangement of the first drive shaft 51 and the first detector 61 in the second support member 16 is different from arrangement of the second drive shaft 151 and the second detector 161 in the fourth support member 22 depending on a difference between input positions of driving forces from the first operation mechanism 30 and the second operation mechanism 130.

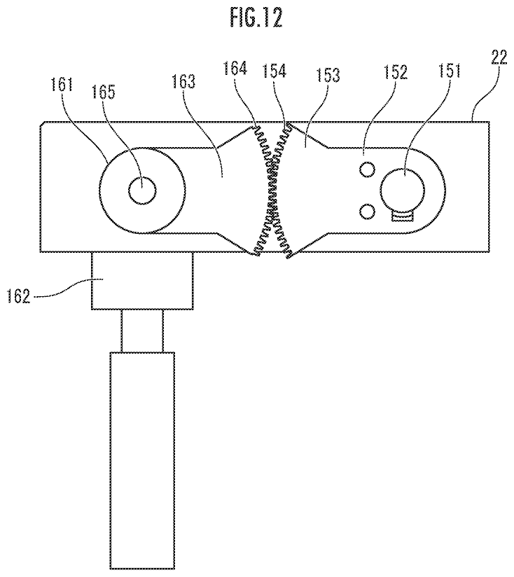

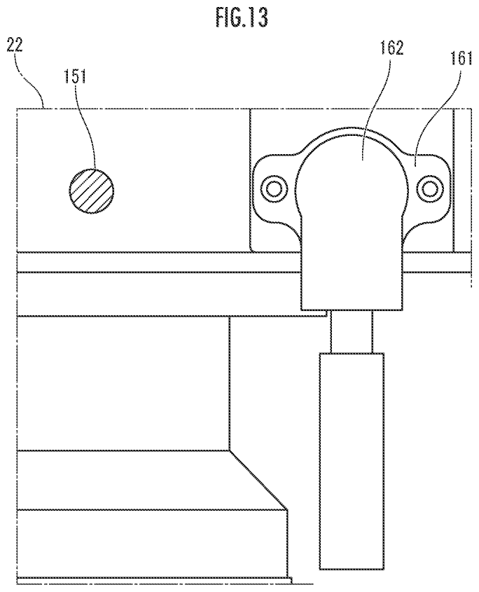

FIG. 12 shows a C-C cross-sectional view of FIG. 5 and shows the fourth support member 22 seen from the operation lever 1 side. Also, FIG. 13 shows a D-D cross-sectional view of FIG. 5 and shows a surface of the fourth support member 22 opposite to FIG. 12. When seen from the operation lever 1 side, the first drive shaft 51 of the second support member 16 is disposed on a left end side of the second support member 16. On the other hand, the second drive shaft 151 of the fourth support member 22 is disposed on a right end side of the fourth support member 22.

The second drive shaft 151 is a cylindrical rotary shaft and includes a second rotation output part 152 which outputs rotation of the second drive shaft 151 to between opposite ends of the second drive shaft 151. The second rotation output part 152 includes a second transmission part 153 formed to extend toward the second detector 161. The second transmission part 153 is a substantially fan-shaped member including a circular arc portion of a disk having a constant radius and includes a third teeth portion 154 formed on a circular arc around the central axis Y0 as a center of the circular arc. The second drive shaft 151 is inserted into the shaft hole 23 provided in the fourth support member 22 as shown in FIG. 5 and is therefore rotatably held.

The second detector 161 is a member to detect a rotation angle of the second drive shaft 151. The second detector 161 includes a second detector body 162, a second rotation part 163 to which rotation is transmitted from the second transmission part 153, and a coupling shaft 165 coupling the second rotation part 163 and the second detector body 162. The second detector body 162 is, for example, a potentiometer. The second rotation part 163 is a member including a substantially fan-shaped part having a circular arc portion and is fixed to the coupling shaft 165 by fitting the coupling shaft 165 into a hole formed in a substantially oval portion continuous with the circular arc portion. The second rotation part 163 includes a fourth teeth portion 164 formed on a circular arc around a central axis of the coupling shaft 165 as a circular arc center.

The coupling shaft 165 is inserted into the shaft hole 24 provided in the fourth support member 22 as shown in FIG. 5, and rotatably held. The second rotation part 163 is coupled to an end of the coupling shaft 165 on the same side as in the second transmission part 153. Also, the second detector body 162 is coupled to an end of the coupling shaft 165 opposite to the second rotation part 163. The third teeth portion 154 of the second transmission part 153 and the fourth teeth portion 164 of the second rotation part 163 are arranged in a state of being meshed with each other. Therefore, the rotation of the second drive shaft 151 is transmitted to the second detector body 162 via the second transmission part 153, the second rotation part 163, and the coupling shaft 165. Specifically, the second detector 161 includes the second rotation part 163 to be rotated by the third teeth portion 154 and detects the rotation of the second rotation part 163, to detect a tilting amount of the operation lever 1 to the second direction (T-direction).

The second drive shaft 151 disposed in the fourth support member 22 and the second detector 161 can be formed to be different from the first drive shaft 51 disposed in the second support member 16 and the first detector 61, in a basic shape including each dimension, detection properties of the detector and the like.

For example, an interaxial distance between the first drive shaft 51 in the second support member 16 and the coupling shaft 65 of the first detector 61 can be different from an interaxial distance between the second drive shaft 151 in the fourth support member 22 and the coupling shaft 165 of the second detector 161 in arrangement. In this case, lengths of the first transmission part 53 and the second transmission part 153 and lengths of the first rotation part 63 and the second rotation part 163 may be determined as appropriate.

The detection properties of the first detector 61 disposed in the fourth support member 22 can be different properties from the detection properties of the first detector 61 disposed in the second support member 16, depending on a difference in control content for the operation lever 1 between the S-direction that is the first direction and the T-direction that is the second direction. For example, to differently set an output proportionality constant to the rotation angle, the detection properties of the first detector 61 can be set to be different from the detection properties of the second detector 161.

The first drive shaft 51 and the second drive shaft 151 as well as the first detector 61 and the second detector 161 have been described above. Also, the same member may be used in the first drive shaft 51 and the second drive shaft 151, and/or the first detector 61 and the second detector 161. The use of the same member can achieve cost reduction due to use of common parts.

Referring to FIGS. 3 and 5, description will be made as to the first-direction guide member 71. The first-direction guide member 71 is a member which operates the operation lever 1 in the S-direction that is the first direction depending on an applied driving force. The first-direction guide member 71 includes two first longitudinal members 72 and 72 which have the same length and are linear, two first short members 73 and 73 coupling one ends of the two first longitudinal members 72 and 72 to each other and other ends of the members to each other, respectively, and a first bearing part 74 and a second bearing part 75 provided in the two first short members 73 and 73, respectively.

The two first longitudinal members 72 and 72 and two first short members 73 and 73 are combined with one another and assembled in a substantially quadrangular frame. The opposite ends of each of two first longitudinal members 72 and 72 are fixed to two first short members 73 and 73, respectively, with bolts in a state where the operation lever base end 2 is sandwiched from opposite sides between two first longitudinal members 72 and 72 via a slight gap from the operation lever 1.

Also, two first short members 73 and 73 are provided with the first bearing part 74 and the second bearing part 75 extending perpendicularly downward from the first short members 73 and 73, respectively. The first bearing part 74 and the second bearing part 75 are rotatable around the axis X0 of the first drive shaft 51. Upon rotation of the first bearing part 74 and the second bearing part 75, the first-direction guide member 71 also integrally rotates.

Therefore, the first-direction guide member 71 is rotatable to the first support member 13 and the second support member 16. As described above, the first-direction guide member 71 rotatably pivotally supported in the state where the operation lever 1 is sandwiched rotates depending on the driving force transmitted from the first operation mechanism 30 via the first drive shaft 51 as described later, and the first longitudinal members 72 and 72 press the operation lever base end 2 to tilt the operation lever 1 in the first direction.

Note that a method of supporting the first-direction guide member 71 to the base plate 11 may be any other method as long as the first-direction guide member 71 is pivotally supported in a rotatable manner to the base plate 11.

Referring to FIGS. 3 and 5, the second-direction guide member 171 will be described. The second-direction guide member 171 is a member which operates the operation lever 1 in the T-direction that is the second direction depending on the applied driving force. As shown in FIGS. 3 and 5, the second-direction guide member 171 is disposed above the first-direction guide member 71 to intersect and cover the first-direction guide member. The second-direction guide member 171 includes two second longitudinal members 172 and 172 which have the same length and are entirely uniformly curved excluding opposite ends, two second short members 173 and 173 coupling one ends of the two second longitudinal members 172 and 172 to each other and other ends of the members to each other, respectively, and a third bearing part 174 and a fourth bearing part 175 provided in the two second short members 173 and 173, respectively.

The two second longitudinal members 172 and 172 and two second short members 173 and 173 are combined with one another and assembled in a substantially quadrangular frame. The opposite ends of each of the two second longitudinal members 172 and 172 are fixed to the two second short members 173 and 173, respectively, with bolts in a state where the operation lever base end 2 is sandwiched from opposite sides between the two second longitudinal members 172 and 172 via a slight gap from the operation lever 1.

Also, the two second short members 173 and 173 are provided with the third bearing part 174 and the fourth bearing part 175 extending perpendicularly downward from the second short members 173 and 173, respectively. The third bearing part 174 and the fourth bearing part 175 are rotatable around the axis Y0 of the second drive shaft 151. Upon rotation of the third bearing part 174 and the fourth bearing part 175, the second-direction guide member 171 also integrally rotates.

Therefore, the second-direction guide member 171 is rotatable to the second support member 16 and the fourth support member 22. As described above, the second-direction guide member 171 rotatably pivotally supported in the state where the operation lever 1 is sandwiched rotates depending on the driving force transmitted from the second operation mechanism 130 via the second drive shaft 151 as described later, and the second longitudinal members 172 and 172 press the operation lever base end 2 to tilt the operation lever 1 in the second direction.

Referring to FIGS. 3 to 6, the first actuator 31 included in the first operation mechanism 30, and the first transmission device 41 are described. The first actuator 31 includes therein an unshown rotation mechanism and a first rotary shaft 32. The rotation mechanism rotates with electric energy and rotates the first rotary shaft 32. The first actuator 31 and the first rotary shaft 32 are, for example, an electric motor and a motor output shaft, respectively.

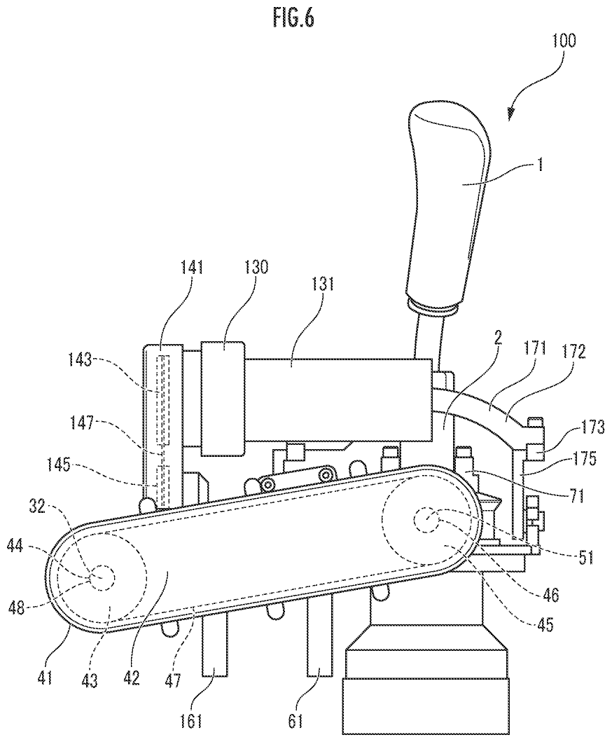

FIG. 6 shows the first transmission device 41. The first transmission device 41 transmits the driving force generated by the first actuator 31 to the first-direction guide member 71. The first transmission device 41 includes a first transmission input member 43, a first transmission output member 45, a first transmission member 47, and a first case 42 containing therein these members. In a center of the first transmission input member 43, a first input engagement hole 44 is provided. Also, in the first case 42 adjacent to one surface side of the first transmission input member 43, a hole corresponding to an outer diameter of a peripheral part of the first rotary shaft 32 of the first actuator 31 is opened.

The first rotary shaft 32 is inserted into the first input engagement hole 44 in a state of being relatively non-rotatable to the first transmission input member 43. Also, the peripheral part of the first rotary shaft 32 of the first actuator 31 is joined to an opening in the first case 42. The first transmission member 47 is disposed perpendicularly to an axial direction of the first rotary shaft 32 of the first actuator 31. Therefore, the first transmission device 41 is connected perpendicularly to the first actuator 31. The first input engagement hole 44, into which the first rotary shaft 32 is inserted, is included in a first connection part 48 that is a part connecting the first actuator 31 and the first transmission device 41.

The first case 42 has a hollow and substantially oval shape, and the disk-shaped first transmission input member 43 is pivotally supported in a rotatable manner inside one end of the first case 42 and the disk-shaped first transmission output member 45 is pivotally supported in a rotatable manner inside the other end of first case 42. The annular first transmission member 47 is hung around outer circumferences of the first transmission input member 43 and the first transmission output member 45. When the first actuator 31 rotates the first transmission input member 43, the rotation is transmitted to the first transmission output member 45 via the first transmission member 47. The first transmission input member 43, the first transmission output member 45, and the first transmission member 47 are, for example, an input side pulley, an output side pulley, and an annular member such as a belt or a chain, respectively.

In a center of the first transmission output member 45, a first output engagement hole 46 is provided. The first drive shaft 51 is inserted into the first output engagement hole 46 through an opening provided around the first transmission output member 45 of the first case 42. The first transmission output member 45 and the first drive shaft 51 are relatively non-rotatably fixed, and the rotation of the first transmission output member 45 is transmitted to the first drive shaft 51. Specifically, the rotation of the first actuator 31 is transmitted to the first drive shaft 51 via the first transmission input member 43, the first transmission member 47, and the first transmission output member 45. The first drive shaft 51 rotates the first-direction guide member 71, and the operation lever 1 is accordingly tilted in the first direction that is the S-direction.

Referring to FIGS. 3 to 5 and 7, a second actuator 131 included in the second operation mechanism 130, and a second transmission device 141 are described. The second actuator 131 has the same structure as in the first actuator 31. The second actuator 131 includes therein an unshown rotation mechanism and a second rotary shaft 132. The rotation mechanism rotates with electric energy and rotates the second rotary shaft 132. In the following description of the second operation mechanism 130, items common to the first operation mechanism 30 are not described.

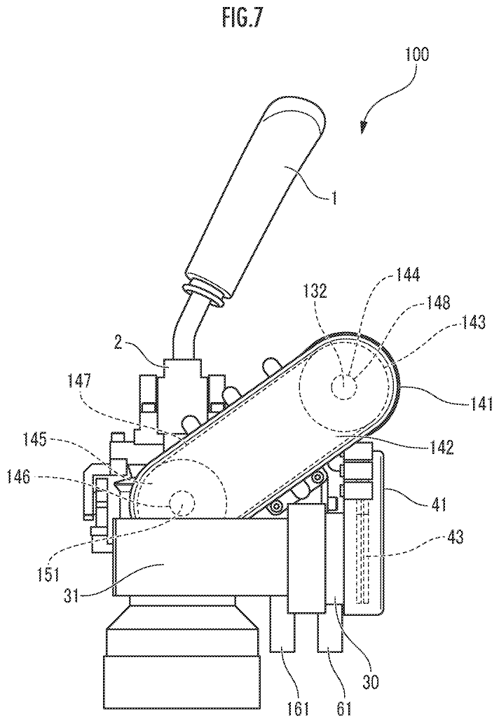

FIG. 7 shows the second transmission device 141. The second transmission device 141 is a device which transmits a driving force generated by the second actuator 131 to the second-direction guide member 171. The second transmission device 141 includes a second transmission input member 143, a second transmission output member 145, a second transmission member 147, and a second case 142 containing therein these members. For the second transmission input member 143, a second input engagement hole 144 is provided in a center of the second transmission input member 143. Also, in the second case 142 adjacent to one surface side of the second transmission input member 143, a hole corresponding to an outer diameter of a peripheral part of the second rotary shaft 132 of the second actuator 131 is opened.

The second rotary shaft 132 is inserted into the second input engagement hole 144 in a state of being relatively non-rotatable to the second transmission input member 143. Also, the peripheral part of the second rotary shaft 132 of the second actuator 131 is joined to an opening in the second case 142. The second transmission member 147 is disposed perpendicularly to an axial direction of the second rotary shaft 132 of the second actuator 131. Therefore, the second transmission device 141 is connected perpendicularly to the second actuator 131. The second input engagement hole 144, into which the second rotary shaft 132 is inserted, is included in a second connection part 148 that is a part connecting the second actuator 131 and the second transmission device 141.

The second case 142 has a hollow and substantially oval shape, and the disk-like second transmission input member 143 is pivotally supported in a rotatable manner inside one end of second case 142 and the disk-shaped second transmission output member 145 is pivotally supported in a rotatable manner inside the other end of second case 142. The annular second transmission member 147 is hung around outer circumferences of the second transmission input member 143 and the second transmission output member 145. When the second actuator 131 rotates the second transmission input member 143, the rotation is transmitted to the second transmission output member 145 via the second transmission member 147. The second transmission input member 143, the second transmission output member 145, and the second transmission member 147 are, for example, an input side pulley, an output side pulley, and an annular member such as a belt or a chain, respectively.

In a center of the second transmission output member 145, a second output engagement hole 146 is provided. The second drive shaft 151 is inserted into the second output engagement hole 146 through an opening provided around the second transmission output member 145 of the second case 142. The second transmission output member 145 and the second drive shaft 151 are relatively non-rotatably fixed, and the rotation of the second transmission output member 145 is transmitted to the second drive shaft 151. Specifically, the rotation of the second actuator 131 is transmitted to the second drive shaft 151 via the second transmission input member 143, the second transmission member 147, and the second transmission output member 145. The second drive shaft 151 rotates the second-direction guide member 171, and the operation lever 1 is accordingly tilted in the second direction that is the T-direction.

Next, the remote driving device 300 on a left side will be described. The left remote driving device 300 includes the operation lever 201 tiltable in two intersecting directions in the same manner as in the right remote driving device 100. The left operation lever 201 has a shape different from the shape of the right operation lever 1. The right operation lever 1 and the left operation lever 201 are same in that both the levers are formed by being bent at one point directly on the operation lever base end 2 and one point directly on an operation lever base end 202, and the levers are different from each other in bending direction. As seen from FIGS. 1 and 2, the right operation lever 1 and the left operation lever 201 are respectively bent to a center line side in the front-rear direction of the seat 501 to make it easier to operate the levers. Also, FIG. 7 that is a front view of the right operation lever 1 and FIG. 9 that is a front view of the left operation lever 201 show the difference in bending direction.

The left remote driving device 300 is disposed relative to the right remote driving device 100 with left-right difference to a center line in the front-rear direction of the seat 501, that is, symmetrically. Additionally, constituent components of the left remote driving device 300 are different from the right remote driving device 100 only in detailed dimensions due to a difference in peripheral part structure including the console boxes 502 and 503, switches and the like. Therefore, a main configuration of the left remote driving device 300 will be described, and details are not described. Note that as the constituent components of the left remote driving device 300, the same components as in at least some of the constituent components of the right remote driving device 100 may be used for the configuration.

Referring to FIGS. 1, 2, 8, and 9, the left remote driving device 300 will be described. The left remote driving device 300 includes a first operation mechanism 230, a second operation mechanism 330, an unshown support device, and the operation lever 201. The first operation mechanism 230, the second operation mechanism 330, the support device, and the operation lever 201 correspond to the first operation mechanism 30, the second operation mechanism 130, the support device 10, and the operation lever 1 which are included in the right remote driving device 100, respectively. The first operation mechanism 230 and the second operation mechanism 330 are mechanisms which respectively tilt the operation lever 201 in the S-direction (drivers cab front-rear direction) that is the first direction and the T-direction (drivers cab left-right direction) that is the second direction.

The left remote driving device 300 includes a configuration corresponding to the right remote driving device 100 as follows.

The first operation mechanism 230 includes a first actuator 231 which generates the driving force, a first transmission device 241 which transmits the driving force of the first actuator 231, a first drive shaft 251, a first detector 261, and a first-direction guide member 271.

Also, the second operation mechanism 330 includes a first actuator 331 which generates the driving force, a first transmission device 341 which transmits the driving force of the first actuator 331, a first drive shaft 351, a first detector 361, and a first-direction guide member 371.

Further, the unshown support device of the left remote driving device 300 includes a substantially quadrangular base plate, as well as a first support member, a second support member, a third support member, and a fourth support member which are arranged adjacent to four sides of a substantially quadrangular shape of the base plate, respectively, in the same manner as in the support device 10 of the right remote driving device 100. Also, arrangement of the respective members is similar to that of the support device 10 of the right remote driving device 100.

The first operation mechanism 230, second operation mechanism 330, and support device described above include respective constituent components which are the same as the respective corresponding constituent components of the right remote driving device 100, and hence the individual constituent components are not described.

Hereinafter, characteristics of the arrangement of the first operation mechanism 30 and the second operation mechanism 130 and effects obtained from the characteristics will be described. Note that description will be made below as to the right remote driving device 100, and the same effects can be obtained from the left remote driving device 300.

(1) Arrangement of First Rotation Output Part 52 and Second Rotation Output Part 152 on First Drive Shaft 51 and Second Drive Shaft 151

The first detector 61 and the second detector 161 are configured to detect the rotations of the first drive shaft 51 and the second drive shaft 151 via the first rotation output part 52 and the second rotation output part 152, that is, the tilting amounts of the operation lever 1 in the first direction (S-direction) and the second direction (T-direction), respectively. The first detector 61 and the second detector 161 perform the detections via the first rotation output part 52 and the second rotation output part 152 and are therefore arranged at positions away from the first drive shaft 51 and the second drive shaft 151, respectively.

FIG. 5 shows lengths of the first rotation output part 52 and the second rotation output part 152, as well as the first detector 61 and the second detector 161, in a first drive shaft 51 direction. The length of the first detector 61 in the first drive shaft 51 direction is denoted with F, and the length of the first rotation output part 52 in the first drive shaft 51 direction is denoted with E. As is clear from FIG. 5, the length E is set to be remarkably smaller than the length F to reduce a projecting amount.

Also, a length of the second detector 161 in a second drive shaft 151 direction is denoted with H, and a length of the second rotation output part 152 in the second drive shaft 151 direction is denoted with G. As is clear from FIG. 5, the length G is set to be remarkably smaller than the length H to reduce a projecting amount. Specifically, the length of the first rotation output part 52 in the first drive shaft direction is set to be shorter than the length in the first drive shaft direction in a case where the first detector 61 is disposed on the first drive shaft 51. Also, the length of the second rotation output part 152 in the second drive shaft direction is set to be shorter than the length in the second drive shaft direction in a case where the second detector 161 is disposed on the second drive shaft 151.

Therefore, a space to be reserved reduces as compared with the case where the first detector 61 is disposed on the first drive shaft 51 and the second detector 161 is disposed on the second drive shaft 151, so that external dimensions of the remote driving device 100 in the first drive shaft direction and the second drive shaft direction can be suppressed. Also, the rotation output part disposed on the first drive shaft 51 is formed of the plate-shaped member with the substantially fan shape and is remarkably thinner than the first detector 61 and the second detector 161, so that the above effect can be further noticeably obtained.

Specifically, the space to be reserved on the first drive shaft 51 reduces, so that the remote driving device 100 can be disposed not to project to the seat. Also, the space to be reserved on the second drive shaft 151 reduces, so that the remote driving device 100 can be disposed not to protrude to a boarding/alighting passage (front side) where the operator passes to sit on the seat.

(2) Arrangement of First Rotary Shaft 32 and Second Rotary Shaft 132 Parallel to and Offset from First Drive Shaft 51 and Second Drive Shaft 151

Description is made with reference to FIG. 4. The first transmission member 47 is disposed extending in a direction perpendicular to the axial direction of the first rotary shaft 32 of the first actuator 31, and the first drive shaft 51 inserted into the first transmission output member 45 is disposed in a direction perpendicular to an extending direction of the first transmission member 47. Therefore, the first rotary shaft 32 of the first actuator 31 is disposed parallel to and offset from the first drive shaft 51.

Similarly, the second transmission member 147 is disposed extending in a direction perpendicular to the axial direction of the second rotary shaft 132 of the second actuator 131, and the second drive shaft 151 inserted into the second transmission output member 145 is disposed in a direction perpendicular to an extending direction of the second transmission member 147. Therefore, the second rotary shaft 132 of the second actuator 131 is disposed parallel to and offset from the second drive shaft 151. According to the above arrangement, the remote driving device 100 can be easily retrofitted by effective use of a limited space around the operation lever 1.

(3) Arrangement of First Transmission Device 41 and Second Transmission Device 141 Overlapping in Up-Down Direction

Description is made with reference to FIGS. 4 and 5. FIG. 4 shows that the axis X0 of the first drive shaft 51 intersects the axis Y0 of the second drive shaft 151. A virtual plane J shown in FIG. 4 is a plane including the axis X0 of the first drive shaft 51 and the axis Y0 of the second drive shaft 151, and an arrow K indicates a direction perpendicular to the virtual plane J. FIG. 5 shows that a part of the second transmission device 141 in which the second connection part 148 is shown overlaps with the first transmission device 41 in the directional view K parallel to the arrow K.

Also, description is made as to a case where the first drive shaft 51 and the second drive shaft 151 shift in the up-down direction and do not intersect. Also, in this case, when seen in a directional view parallel to a straight line connecting the first drive shaft 51 and the second drive shaft 151 at the shortest distance, that is, the directional view K, a part of the second transmission device 141 in which the second connection part 148 is shown overlaps with the first transmission device 41 in the same manner as above. According to this arrangement, at least parts of the first transmission device 41 and the second transmission device 141 are arranged three-dimensionally overlapping in the up-down direction, so that the remote driving device 100 can be easily retrofitted in the limited space around the operation lever 1 of the vehicle.

(4) Arrangement of First Connection Part 48 and Second Connection Part 148

FIG. 5 shows the first connection part 48 of the first transmission device 41 to which the first actuator 31 is connected, and the second connection part 148 of the second transmission device 141 to which the second actuator 131 is connected. In a plan view of FIG. 5, a vertically extending virtual plane including the first drive shaft 51 is a virtual plane M overlapping with the central axis X0. Also, a vertically extending virtual plane including the second drive shaft 151 is a virtual plane L overlapping with the central axis Y0.

In FIG. 5, the virtual plane M intersects the virtual plane L to define four regions. Both the first connection part 48 and the second connection part 148 are included in a lower right region of FIG. 5, that is, a region XY1 of the four regions. According to this arrangement, the remote driving device 100 can be received in a region range in one of vehicle front and rear directions, and one of vehicle left and right directions relative to the operation lever 1, and the remote driving device 100 can be easily retrofitted in the limited space around the operation lever 1.

Hereinafter, description will be made as to a remote operation system S according to an embodiment with reference to the drawings.

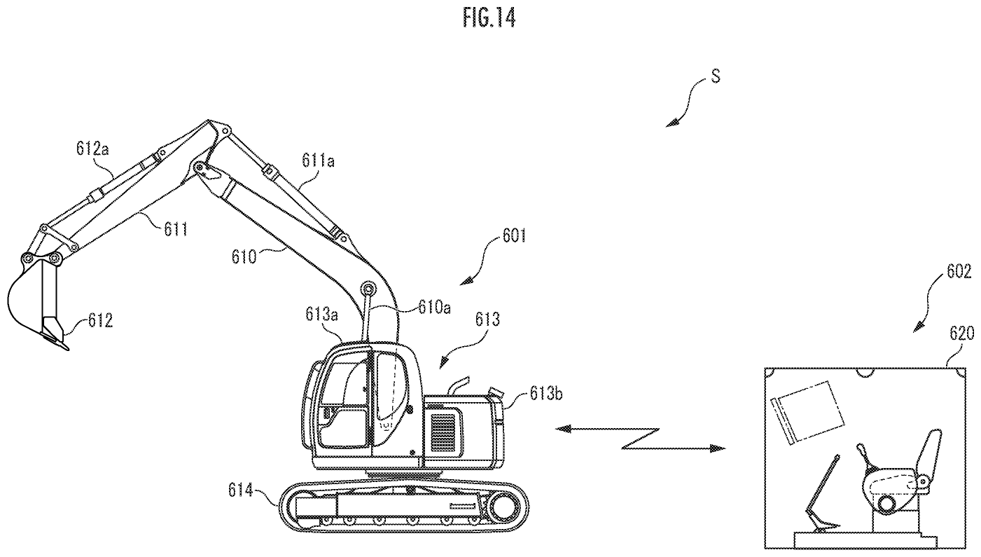

First, referring to FIGS. 14 to 16, description is made as to a configuration of the remote operation system S.

As shown in FIG. 14, the remote operation system S comprises a work machine 601 that is a hydraulic excavator, and a remote operation apparatus 602 to remotely operate the work machine 601. The work machine 601 can be manipulated directly by the operator boarding or can be manipulated indirectly via the remote operation apparatus 602 without any operator boarding.

Note that in the present embodiment, the work machine is the hydraulic excavator. However, the work machine of the present invention is not limited to the hydraulic excavator, and may be, for example, the mobile crane, the dump truck or the like.

The work machine 601 comprises a working machine including a boom 610, an arm 611, and an attachment 612, a swivel body 613 on which the working machine is mounted, and a running body 614 which rotatably supports the swivel body 613.

A base end of the boom 610 is swingably attached to a front part of the swivel body 613. The boom 610 includes a first hydraulic cylinder 610a attached to the boom 610 and the swivel body 613 at the opposite ends. The boom 610 is swung to the swivel body 613 by an extending and retracting operation of the first hydraulic cylinder 610a.

A base end of the arm 611 is swingably attached to a tip end of the boom 610. The arm 611 includes a second hydraulic cylinder 611a attached to the arm 611 and the boom 610 at the opposite ends. The arm 611 is swung to the boom 610 by an extending and retracting operation of the second hydraulic cylinder 611a.

The attachment 612 is swingably attached to a tip end of the arm 611. The attachment 612 includes a third hydraulic cylinder 612a attached to the attachment 612 and the arm 611 at the opposite ends. The attachment 612 is swung to the arm 611 by an extending and retracting operation of the third hydraulic cylinder 612a.

Note that in the present embodiment, a bucket is used as the attachment 612. However, the attachment 612 is not limited to the bucket, and may be any other attachment (e.g., a crushing machine, a braker, a magnet or the like).

The swivel body 613 is configured to swivel around a yaw axis to the running body 614 by a swiveling hydraulic motor (not shown). In a front part of the swivel body 613, a drivers cab 613a for the operator to board is provided, and in a rear part of the swivel body 613, a machine room 613b is provided.

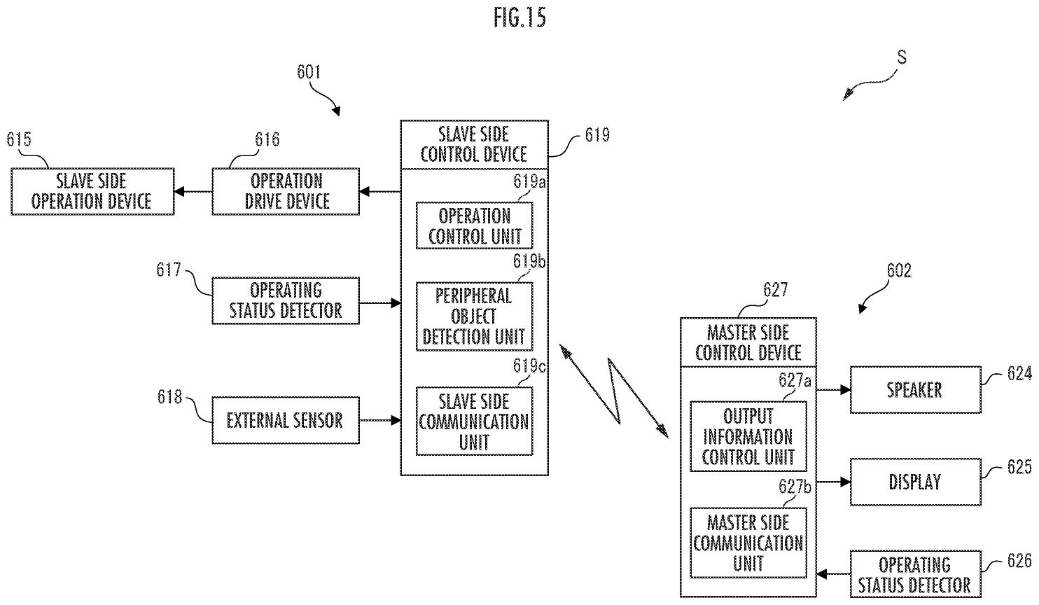

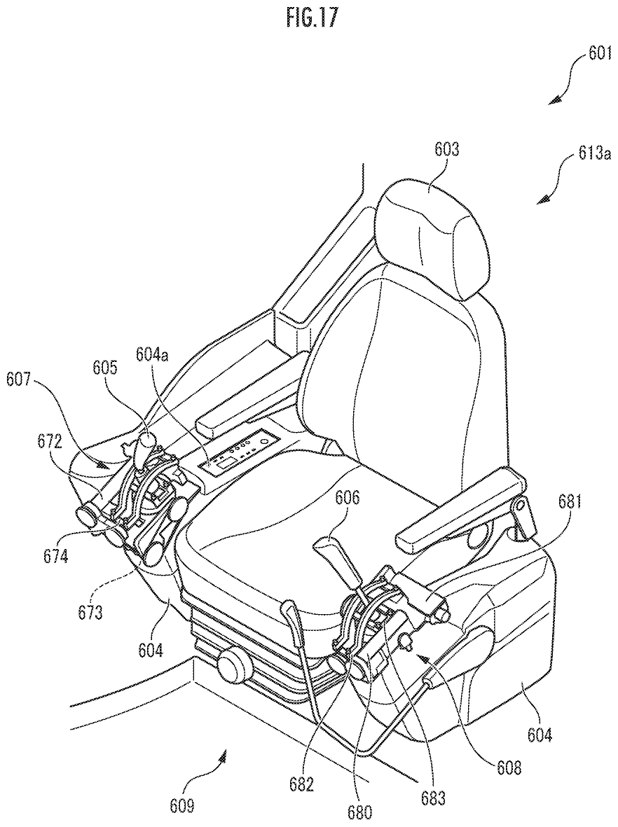

In the drivers cab 613a, a slave side operation device 615 (see FIG. 15) for manipulating the work machine 601 is disposed. The slave side operation device 615 is, for example, an operation pedal, an operation switch, after-mentioned fourth operation lever 605 and fifth operation lever 606 (see FIG. 17) or the like. Additionally, the fourth operation lever 605 corresponds to the operation lever 1, and the fifth operation lever 606 corresponds to the operation lever 201.

In the machine room 613b, hydraulic equipment (not shown) such as a hydraulic pump, a direction switching valve, or a hydraulic oil tank, an engine (not shown) that is a power source for the hydraulic pump, and others are housed.

The running body 614 is a crawler running body and is driven with a running hydraulic motor (not shown). Additionally, the running body of the work machine of the present invention is not limited to a crawler. For example, the running body may move on wheels, or move with legs. Also, in a case where the work machine is used on the water, the running body may be a pontoon or the like.

Note that the work machine 601 may further include an actuator (e.g., a hydraulic actuator for driving a dozer, a hydraulic actuator included in the attachment of the crushing machine, or the like) other than the above running hydraulic motor, the swiveling hydraulic motor, the first hydraulic cylinder 610a, the second hydraulic cylinder 611a, and the third hydraulic cylinder 612a. Also, some of the actuators of the work machine 601 (e.g., a swiveling actuator) may be electric actuators.

When manipulating the work machine 601, the slave side operation device 615 is operated in a state where the engine is operated, to operate the actuators such as the running hydraulic motor, the swiveling hydraulic motor, the first hydraulic cylinder 610a, the second hydraulic cylinder 611a, and the third hydraulic cylinder 612a. The actuating of each actuator in response to the operation of the slave side operation device 615 may be performed, for example, in the same manner as in a known work machine.

As shown in FIG. 14, in the work machine 601, to enable a remote operation, an electric operation drive device 616 (e.g., a first operation mechanism 607 and a second operation mechanism 608 described later (see FIG. 17)) which drives the slave side operation device 615 is housed in the drivers cab 613a.

The operation drive device 616 is connected to the slave side operation device 615. Alternatively, the operation drive device 616 may be configured to be removable from the work machine 601.

Also, the operation drive device 616 includes a plurality of electric motors (not shown). With a driving force from the electric motor, the operation drive device 616 drives each of the operation pedal, the operation switch, and the after-mentioned fourth operation lever 605 and fifth operation lever 606 (see FIG. 17) which are included in the slave side operation device 615.

Further, the work machine 601 comprises an operating status detector 617 to detect an operating status of the work machine 601, an external sensor 618 that is a camera or the like to detect circumstances around the work machine 601, and a slave side control device 619 capable of executing various control processes.

The operating status detector 617 is, for example, a detector which detects a rotation angle of a swinging operation of each of the boom 610, the arm 611 and the attachment 612 or a stroke length of each of the first hydraulic cylinder 610a, the second hydraulic cylinder 611a and the third hydraulic cylinder 612a, a detector which detects a swivel angle of the swivel body 613, a detector which detects a drive speed of the running body 614, a detector which detects an inclination angle of the swivel body 613 or the running body 614, an inertial sensor which detects an angular velocity or acceleration of the swivel body 613, or the like.

The external sensor 618 includes, for example, the camera, a distance measurement sensor, a radar and the like. The camera and the like included in the external sensor 618 are installed at a plurality of locations such as a periphery of the swivel body 613, to detect objects around the swivel body 613.

The slave side control device 619 includes, for example, one or more electronic circuit units including a microcomputer, a memory, an interface circuit and the like. The slave side control device 619 obtains, as appropriate, a detection signal of each of the operating status detector 617 and the external sensor 618.

The slave side control device 619 has, as functions realized by both or one of an implemented hardware configuration and program (software configuration), a function of an operation control unit 619a, a function of a peripheral object detection unit 619b, and a function of a slave side communication unit 619c.

The operation control unit 619a performs actuation control of the operation drive device 616 (eventually, operation control of the slave side operation device 615) and operation control of the engine in response to the operation of the slave side operation device 615 or an operation command given from a remote operation apparatus 602 side, thereby controlling the operation of the work machine 601.

The peripheral object detection unit 619b detects the object based on the detection signal of the external sensor 618, in a case where there is a person or an object such as an installation in a predetermined target space around the work machine 601.

The slave side communication unit 619c performs, as appropriate, wireless communication with the remote operation apparatus 602 side via an after-mentioned master side communication unit 627b.

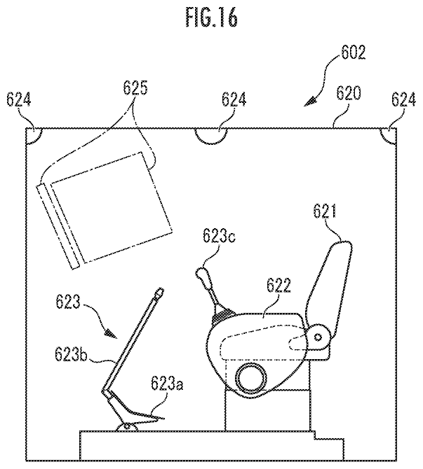

As shown in FIG. 16, the remote operation apparatus 602 comprises, inside a remote operation room 620, a master side seat 621 on which the operator sits, a pair of left and right master side console boxes 622 arranged on left and right of the master side seat 621, a master side operation device 623 operated by the operator for a remote operation of the work machine 601, speakers 624 as output devices of acoustic information (auditory information), and a display 625 as an output device of display information (visual information).

Also, as shown in FIG. 15, the remote operation apparatus 602 comprises an operating status detector 626 to detect an operating status of the master side operation device 623, and a master side control device 627 capable of executing various control processes. Alternatively, the master side control device 627 may be disposed inside or outside the remote operation room 620.

The master side operation device 623 has, for example, a configuration identical or similar to a configuration of the slave side operation device 615 of the work machine 601.

Specifically, the master side operation device 623 includes, for example, a first operation lever 623b with an operation pedal 623a installed in front of the master side seat 621, and a second operation lever (not shown) and a third operation lever 623c which are mounted to the pair of left and right master side console boxes 622, respectively, for the operator sitting on the master side seat 621 to operate.

Alternatively, the master side operation device 623 may have a configuration different from that of the slave side operation device 615 of the work machine 601. For example, the master side operation device 623 may be a portable operation device including a joystick, a manual operation button and the like.

The operating status detector 626 is, for example, a potentiometer, a contact switch or the like incorporated in the master side operation device 623. The operating status detector 626 is configured to output a detection signal indicating an operating status of each operation unit (the operation pedal 623a, first operation lever 623b, second operation lever, third operation lever 623c or the like) of the master side operation device 623.

The speakers 624 are arranged, for example, in a plurality of locations inside the remote operation room 620, such as a front part, a rear part and opposite left and right sides of the remote operation room 620.

The display 625 includes, for example, a liquid crystal display, a head-up display or the like. The display 625 is disposed in front of the master side seat 621, for the operator sitting on the master side seat 621 to visually recognize.

The master side control device 627 includes, for example, one or more electronic circuit units including a microcomputer, a memory, an interface circuit and the like. The master side control device 627 obtains a detection signal of the operating status detector 626 as appropriate. Based on this detection signal, the master side control device 627 recognizes an operation command to the work machine 601 which is predetermined by the operating status of the master side operation device 623.

The master side control device 627 has a function of an output information control unit 627a and a function of the master side communication unit 627b as functions realized by both or one of an implemented hardware configuration and program (software configuration).

The output information control unit 627a controls each speaker 624 and the display 625.

The master side communication unit 627b performs wireless communication with a work machine 601 side via the slave side communication unit 619c as appropriate. Through this wireless communication, the master side control device 627 transmits the operation command for the work machine 601 to the slave side control device 619, and receives, from the slave side control device 619, various pieces of information on the work machine 601 side (video taken by the camera, detection information of the object around the work machine 601, detection information of the operating status of the work machine 601, and the like).

Next, description will be made in detail as to configurations of the first operation mechanism 607 and the second operation mechanism 608 in the operation drive device 616 with reference to FIGS. 17 to 19. Note that the first operation mechanism 607 corresponds to the right remote driving device 100, and the second operation mechanism 608 corresponds to the left remote driving device 300.

As shown in FIG. 17, the work machine 601 comprises, inside the drivers cab 613a, a slave side seat 603 on which the operator sits, and a pair of left and right slave side console boxes 604 arranged on left and right of the slave side seat 603. Note that the slave side seat 603 corresponds to the seat 501, and the slave side console boxes 604 correspond to the console boxes 502 and 503.

Also, the work machine 601 comprises the slave side operation device 615 (see FIG. 15). The slave side operation device 615 includes the fourth operation lever 605 and the fifth operation lever 606 provided in the slave side console boxes 604, respectively, the operation pedal and the like.

Further, the work machine 601 comprises the operation drive device 616 (see FIG. 15). The operation drive device 616 includes the first operation mechanism 607 (operation mechanism for the work machine) and the second operation mechanism 608 (operation mechanism for the work machine) to operate the fourth operation lever 605 and the fifth operation lever 606, respectively, and the like.

Also, a boarding/alighting passage 609 where the operator passes to sit on the slave side seat 603 is formed in front of the slave side seat 603 and the fifth operation lever 606 inside the drivers cab 613a.

The fourth operation lever 605 and the fifth operation lever 606 are arranged in front ends of the slave side console boxes 604, and the first operation mechanism 607 and the second operation mechanism 608 are attached to the front ends of the slave side console boxes 604, respectively, to surround corresponding base ends of the fourth operation lever 605 and the fifth operation lever 606.

A control panel 604a is provided at a position behind the fourth operation lever 605 in the slave side console box 604 on the right side of the operator in a seated state (on a left side in FIG. 17) in the left and right slave side console boxes 604. The operation switch is disposed in the control panel 604a.

The fourth operation lever 605 and the fifth operation lever 606 send a signal to the slave side control device 619 (see FIG. 15) depending on a tilting angle and a tilting direction. The slave side control device 619 controls an operation amount of the work machine 601 (e.g., the swing angle and the like of the boom 610 and the arm 611 in the present embodiment) based on the signal.

The first operation mechanism 607 and the second operation mechanism 608 tilt the corresponding fourth operation lever 605 and fifth operation lever 606 based on the operation command from the remote operation apparatus 602. Specifically, the first operation mechanism 607 tilts the fourth operation lever 605 in response to the tilting of the second operation lever (not shown) of the remote operation apparatus 602. Also, the second operation mechanism 608 tilts the fifth operation lever 606 in response to the tilting of the third operation lever 623c (see FIG. 16) of the remote operation apparatus 602.

Hereinafter, description will be made as to the first operation mechanism 607 and the second operation mechanism 608 that are operation mechanisms for the work machine according to the embodiment of the present invention. The first operation mechanism 607 and second operation mechanism 608 include a similar configuration, and hence the first operation mechanism 607 will be described in detail.

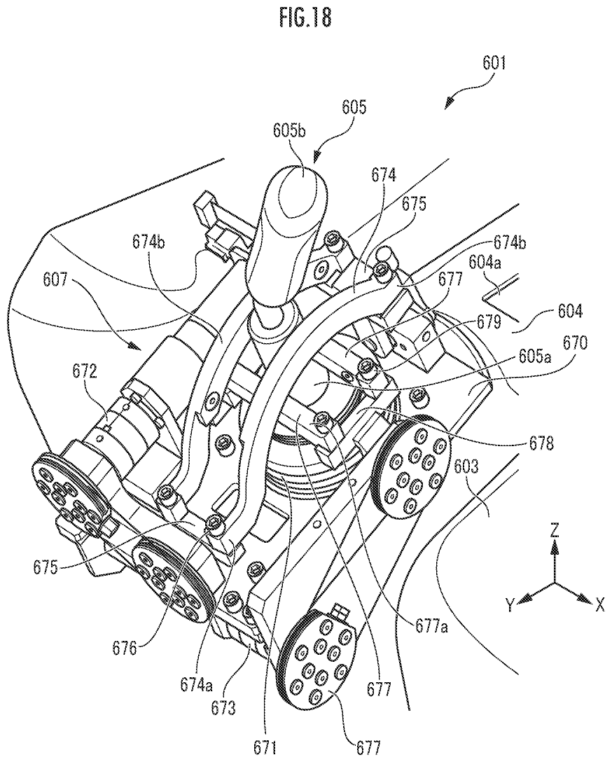

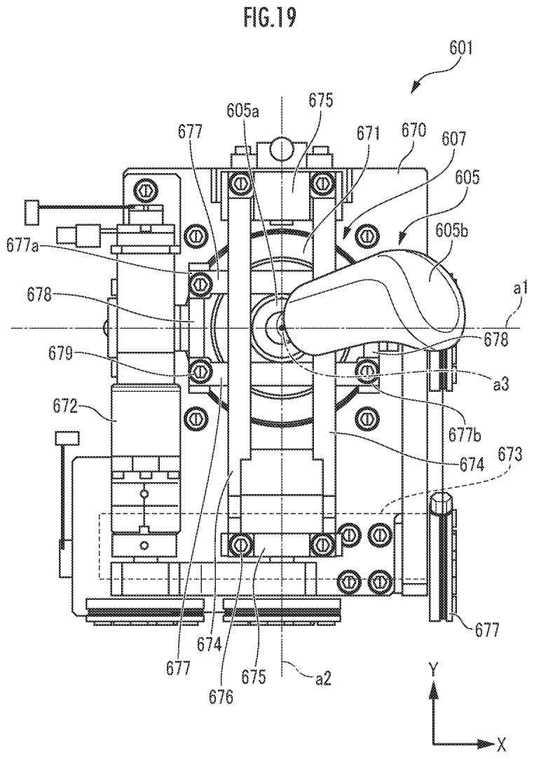

As shown in a perspective view of FIG. 18 and a plan view of FIG. 19, the first operation mechanism 607 comprises a plate 670 fixed to a top surface of the slave side console box 604, and a support member 671 tiltably pivotally supporting the fourth operation lever 605 in a center of a top surface side of the plate 670. The plate 670 is a rectangular flat plate-shaped member. Additionally, the plate 670 corresponds to the base plate 11.

The support member 671 tiltably pivotally supports a base end 605a of the fourth operation lever 605 in a left-right direction that is a first direction and a front-rear direction (up-down direction in FIG. 19) that is a second direction orthogonal to the first direction. Note that the base end 605a corresponds to the operation lever base end 2.

Also, the first operation mechanism 607 comprises a first actuator 672 disposed on the top surface side of the plate 670 (front side in FIGS. 18 and 19), and a second actuator 673 disposed on a bottom surface side of the plate 670 (back side in FIGS. 18 and 19). Note that the first actuator 672 corresponds to the second actuator 131, and the second actuator 673 corresponds to the first actuator 31.

The first actuator 672 and the second actuator 673 are electric actuators. The first actuator 672 generates a driving force to rotate around an axis extending along the up-down direction from a rotation axis (not shown) provided in bottom end. The second actuator 673 generates a driving force to rotate around an axis extending along the left-right direction from a rotation axis (not shown) provided in a left end.

Also, the first operation mechanism 607 comprises a pair of first guide members 674 and 674 extending in a front-rear direction on the top surface side of the plate 670, and a pair of second guide members 677 and 677 extending in the left-right direction on the top surface side of the plate 670 and below the pair of first guide members 674 and 674. The first guide members 674 and 674 and the second guide members 677 and 677 correspond to guide members of the present invention. Note that the first guide member 674 corresponds to the second-direction guide member 171, and the second guide member 677 corresponds to the first-direction guide member 71.

Each of the pair of left and right first guide members 674 and 674 includes an arched member. The pair of first guide members 674 and 674 extend in an arched shape in the front-rear direction from a front end 674a that is one end on a front side toward a rear end 674b that is the other end on a rear side to sandwich the base end 605a of the fourth operation lever 605. The pair of first guide members 674 and 674 are attached to a pair of first rotation members 675 corresponds to a pair of support members of the present invention.

Specifically, the front ends 674a and 674a of the respective first guide members 674 and 674 are attached to the first rotation member 675 located on a front side. The rear ends 674b and 674b of the respective first guide members 674 and 674 are attached to the first rotation member 675 located on a rear side.

These members are attached by screwing bolts 676 and 676 into bolt holes 675a and 675a formed in the first rotation member 675 in a state where the bolts 676 and 676 are inserted into through holes 674c and 674c formed in the first guide members 674 and 674.

The front first rotation member 675 is directly or indirectly fixed to a rotary shaft of the first actuator 672 and rotates about a second axis a2 extending along the second direction with the driving force generated by the first actuator 672. When the front first rotation member 675 rotates, the pair of first guide members 674 also integrally rotate. As a result, each first guide member 674 presses the base end 605a of the fourth operation lever 605 and tilts the fourth operation lever 605 along a first axis a1 in the left-right direction (first direction).

Each of the pair of front and rear second guide members 677 and 677 includes a rod-shaped member. The pair of second guide members 677 and 677 are provided linearly extending from a left end 677a that is one end on the left side toward a right end 677b that is the other end on the right side in the left-right direction to sandwich the base end 605a of the fourth operation lever 605 between the members. The pair of second guide members 677 and 677 are attached to a pair of second rotation members 678 and 678 corresponding to a pair of support members of the present invention.

Specifically, the right ends 677b and 677b of the second guide members 677 and 677 are respectively attached to the second rotation member 678 located on the right side. The left ends 677a and 677a of the second guide members 677 and 677 are respectively attached to the second rotation member 678 located on the left side.

The attaching is performed by screwing bolts 679 and 679 into bolt holes (not shown) formed in the second rotation member 678 in a state where the bolts are inserted into through holes (not shown) formed in the second guide members 677 and 677.

Here, the left second rotation member 678 is directly or indirectly fixed to a rotary shaft of the second actuator 673 and rotates about the first axis a1 extending along the first direction orthogonal to the second direction with the driving force generated by the second actuator 673. When the left second rotation member 678 rotates, the pair of second guide members 677 also integrally rotate. As a result, the second guide members 677 press the base end 605a of the fourth operation lever 605 and tilt the fourth operation lever 605 along the second axis a2 in the up-down direction (second direction).

Additionally, each second guide member 677 is located below each first guide member 674 (on the back side in FIGS. 18 and 19). However, the first guide member 674 is formed in an arched shape around the first axis a1. Therefore, even in a case where the second guide member 677 rotates, the second guide member 677 does not abut on the first guide member 674.

Note that in the first operation mechanism 607, the first direction is the left-right direction, and the second direction is the front-rear direction. That is, the first direction and the second direction are mutually orthogonal directions. However, the first and second directions of the present invention are not limited to the mutually orthogonal directions, as long as the directions intersect each other. Therefore, the first and second directions may be determined as appropriate depending on a direction in which the operation mechanism tilts the operation lever.

Thus, the first guide member 674 and the second guide member 677 rotate to press the base end 605a of the fourth operation lever 605, thereby tilting the fourth operation lever 605. Therefore, in a case where a gap between the first guide member 674 and second guide member 677 and the base end 605a of the fourth operation lever 605 is not a predetermined interval, there is concern that the fourth operation lever 605 cannot be inclined at a desired inclination angle.

Consequently, an interval between the pair of first guide members 674 and an interval between the pair of second guide members 677 need to be predetermined intervals. To set each interval to the predetermined interval, it is important to precisely perform positioning when fixing the front sides of the pair of first guide member 674 to the first rotation member 675 and positioning when fixing the left sides of the pair of second guide members 677 to the second rotation member 678.

Hereinafter, description will be made as to a positioning mechanism for use in fixing the front sides of the pair of first guide members 674 to the first rotation member 675. In this positioning mechanism, the first direction of the present invention corresponds to a front-rear direction (Y-direction), the second direction of the present invention corresponds to a left-right direction (X-direction), and a third direction of the present invention corresponds to an up-down direction (Z-direction). Additionally, a positioning mechanism in fixing the left sides of the pair of second guide members 677 to the second rotation member 678 is similar to the above mechanism and is not therefore described.

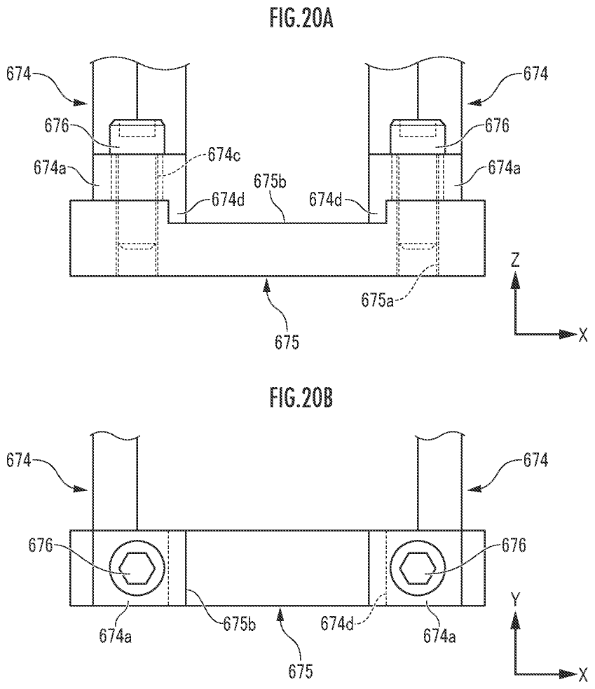

In a first embodiment, as shown in FIGS. 20A and 20B, a protrusion 674d protruding downward from a bottom surface is formed in a portion of the front end 674a of each of the pair of first guide members 674 which is close to the other front end 674a in the left-right direction (X-direction) (on an inner side in the left-right direction). Each protrusion 674d is formed to be flat in the side surface on a side away from the other front end 674a in the left-right direction (X-direction) (on an outer side in the left-right direction).

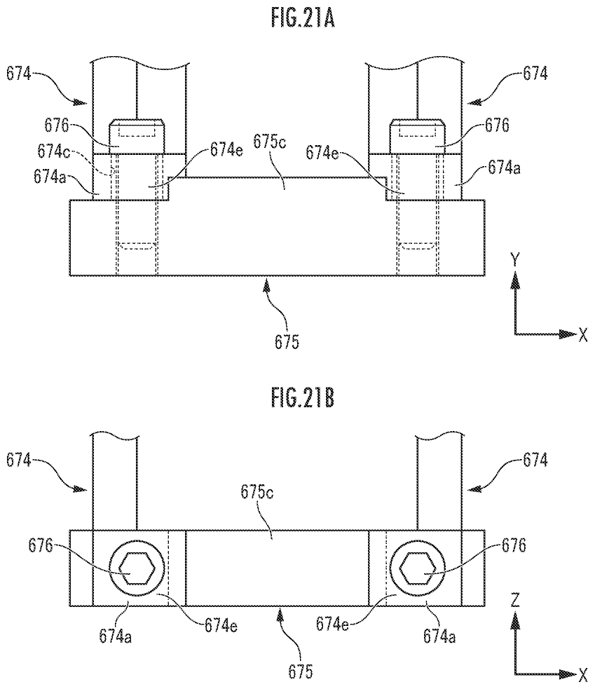

Furthermore, a concave portion 675b is formed in a middle portion of the front first rotation member 675 in the left-right direction. The concave portion 675b is formed by a bottom surface which has a lower height than a top surface of the first rotation member 675 and is formed by a horizontal surface, and a pair of side surfaces each of which connects the top surface of the first rotation member 675 and an end of the bottom surface in a width direction and is formed by a flat surface. Note that in FIGS. 20A and 20B as well as FIGS. 21A and 21B described later, a structure of an attaching part to the first rotation member 675 in the front ends of the pair of first guide members 674 is only depicted.

In this configuration, in a state where the outer surface of the protrusion 674d of each first guide member 674 in the left-right direction abuts on each of opposite side surfaces located outside the concave portion 675b of the first rotation member 675, the bolts 676 and 676 are inserted into the respective through holes 674c and 674c of the pair of first guide members 674, and the bolts 676 and 676 are screwed into the bolt holes 675a and 675a formed in the first rotation member 675. This makes it easier to set, to a predetermined value, the interval between the pair of first guide members 674 which may vary due to a margin for each bolt 676 in the through hole 674c.

Consequently, when attaching each first guide member 674 to the first rotation member 675, at least a part of one side surface of each protrusion 674d in the left-right direction is allowed to abut on the side surface of the concave portion 675b, so that it is possible to securely position the first guide member 674 to the first rotation member 675 in the left-right direction. Here, the outer surface of the first guide member 674 in the left-right direction is positioned with the inner surface of the first rotation member 675 in the left-right direction.

Furthermore, in a modification of the first embodiment, although not shown in the drawing, the protrusions 674d do not have to be formed in the pair of first guide members 674 and 674. In this modification, in a state where the concave portion 675b of the first rotation member 675 is formed with a length in the left-right direction being longer than in the first embodiment such that the interval between the pair of first guide members 674 is the predetermined value, and an outer surface of a bottom portion of each first guide member 674 abuts on each of opposite side surfaces located outside the concave portion 675b, the bolts 676 and 676 may be inserted into the through holes 674c and 674c of the pair of first guide members 674, and the bolts 676 and 676 may be screwed into the bolt holes 675a and 675a formed in the first rotation member 675.

In a second embodiment, as shown in FIGS. 21A and 21B, a protrusion 674e protruding downward from a bottom surface is formed in a portion of a front end 674a of one of a pair of first guide members 674 which is away from a front end 674a of the other first guide member in a left-right direction (X-direction) (on an outer side in the left-right direction). Each protrusion 674e formed to be flat in the side surface on a side closer to the other front end 674a in the left-right direction (X-direction) (on an inner side in the left-right direction). Further, a convex portion 675c is formed in a middle portion of a front first rotation member 675 in the left-right direction. The convex portion 675c is formed by a top surface which has a higher height than a top surface of the first rotation member 675 and is formed by a horizontal surface, and a pair of side surfaces each of which connects the top surface of the first rotation member 675 and an end of a top surface portion in a width direction and is formed by a flat surface.

In this configuration, in a state where the inner surface of the protrusion 674e in the left-right direction of each first guide member 674 abuts on each of opposite side surfaces of the convex portion 675c of the first rotation member 675, bolts 676 and 676 are inserted into through holes 674c and 674c of the pair of first guide members 674, and the bolts 676 and 676 are screwed into the bolt holes 675a and 675a formed in the first rotation member 675. This makes it easier to set, to a predetermined value, an interval between the pair of first guide members 674 which may vary due to a margin for each bolt 676 in the through hole 674c. In this case, the inner surface of each first guide member 674 in the left-right direction is allowed to abut on and positioned with each outer surface of the first rotation member 675 in the left-right direction.

Also, in a modification of the second embodiment, although not shown, the protrusions 674e do not have to be provided in the pair of first guide members 674 and 674. In this modification, in a state where the convex portion 675c of the first rotation member 675 is formed with a length in the left-right direction being shorter than in the second embodiment such that the interval between the pair of first guide members 674 and 674 is the predetermined value, and an inner surface of a bottom portion of each first guide member 674 abuts on each of opposite side surfaces of the convex portion 675c, the bolts 676 and 676 may be inserted into the through holes 674c and 674c of the pair of first guide members 674, and the bolts 676 and 676 may be screwed into the bolt holes 675a and 675a formed in the first rotation member 675.

Note that in the above described first and second embodiments of the operation mechanism for the work machine of the present invention, the case of performing the positioning with the first rotation member 675 in the front end 674a of each of the pair of first guide members 674 has been described, and it is also preferable to similarly perform positioning with the first rotation member 675 in the rear end 674b of each of the pair of first guide members 674.

Furthermore, as described above, an inclination angle of the fourth operation lever 605 depends not only on rotation angles of the first guide member 674 and the second guide member 677 but also on a gap between the first guide member 674 and second guide member 677 and the base end 605a of the fourth operation lever 605. Therefore, when a size of the base end 605a changes, a relation between the rotation angles of the first guide member 674 and second guide member 677 and the inclination angle of the fourth operation lever 605 changes. Therefore, even when the predetermined value of the interval between the pair of first guide members 674 is determined in accordance with the fourth operation lever 605 in which the size (thickness) of the base end 605a is known, there is a need to determine the predetermined value again with the change in size of the base end 605a.

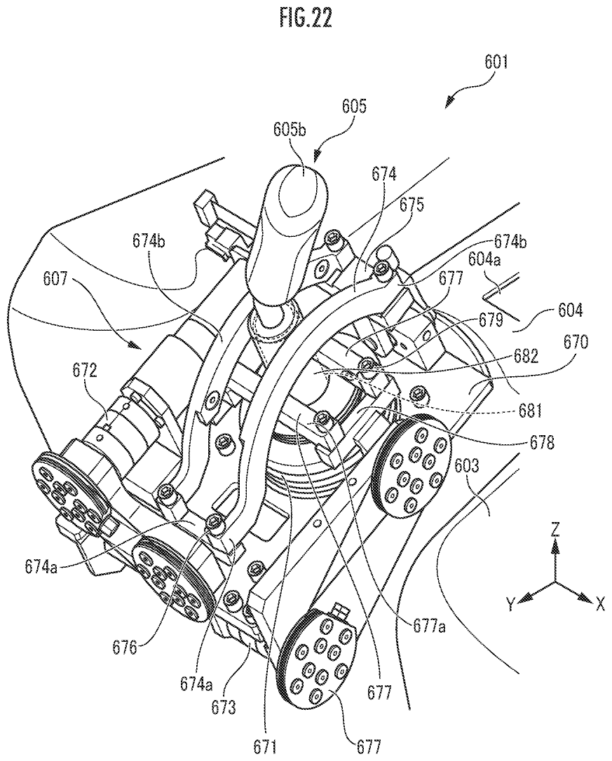

To solve the problem, as shown in FIG. 22, in a case where a base end 681 is smaller than the base end 605a having the size set to the predetermined value, it is preferable to set a size of the base end to the same size as in the base end 605a, by fitting the base end 681 with a cover 682. Additionally, the base end 681 fitted with the cover 682 is not limited to a case where an entire size of the base end is the same as that of the base end 605a and may be applied to a case where portions in contact with a first guide member 674 and a second guide member 677 have the same size (diameter). Note that the cover 682 corresponds to a bracket of the present invention. Alternatively, the guide member 674 may be fitted with a cover.

As described above, according to the first operation mechanism 607 of the embodiment of the operation mechanism for the work machine of the present invention, it is possible to eliminate or reduce positional shift in the left-right direction caused by a mechanical fixing mechanism in attaching the opposite ends 674a and 674b of the pair of guide members 674 and 674 to the pair of first rotation members 675 and 675, respectively, and slight positional shift in the left-right direction during an attaching work. This makes it possible to hold an appropriate clearance for avoiding interference of the fourth operation lever 605 with the guide members 674. Also, each guide member 674 includes the protrusion 674d or the protrusion 674e as a positioning part, and hence a member to position the guide member 674 does not have to be provided separately, so that compact design is possible.

According to the operation mechanism for the work machine of the present invention, when attaching opposite ends of a pair of guide parts to a pair of support members, respectively, it is possible to eliminate or reduce positional shift in the second direction caused by the mechanical fixing mechanism, and slight positional shift in the second direction during the attaching work.

As above, the embodiments shown in the drawings have been described, but the present invention is not limited to such aspects. For example, in the embodiment of the operation mechanism for the work machine of the present invention, the positioning mechanism of the pair of first guide members 674 and 674 with the pair of first rotation members 675 and 675 on the front side may be different from that on the rear side.

Also, the case where the first operation mechanism 607 and the second operation mechanism 608 corresponding to the operation mechanism for the work machine of the present invention rotate as a whole has been described, but the first guide members 674 and 674, the first rotation members 675 and the like may be fixed.

Furthermore, in the present embodiment, the case where the work machine of the present invention includes two mechanisms of the first operation mechanism 607 and second operation mechanism 608 corresponding to the operation mechanism for the work machine of the present invention, but the present invention is not limited to this embodiment, and the work machine of the present invention may comprise one or three or more operation mechanisms corresponding to the operation mechanism for the work machine of the present invention.

### REFERENCE SIGNS LIST

### Right Remote Driving Device Related

1 operation lever
2 operation lever base end
11 base plate
30, 130 first operation mechanism, second operation mechanism
31, 131 first actuator, second actuator
32, 132 first rotary shaft, second rotary shaft
41, 141 first transmission device, second transmission device
51, 151 first drive shaft, second drive shaft
52, 152 first rotation output part, second rotation output part
53, 153 first transmission part, second transmission part
54, 154 first teeth portion, third teeth portion
61, 161 first detector, second detector
63, 163 first rotation part, second rotation part
71, 171 first-direction guide member, second-direction guide member
72, 172 first longitudinal member, second longitudinal member
100 right remote driving device
K directional view
J virtual plane
L virtual plane
M virtual plane

### Left Remote Driving Device Related

201 operation lever
202 operation lever base end
230, 330 first operation mechanism, second operation mechanism
231, 331 first actuator, second actuator
241, 341 first transmission device, second transmission device
251, 351 first drive shaft, second drive shaft
261, 361 first detector, second detector
271, 371 first-direction guide member, second-direction guide member
300 left remote driving device

### Other Devices

500 driving seat of work machine
501 seat
502, 503 console box

### Work Machine Operation Mechanism Related

601 work machine
602 remote operation apparatus
603 slave side seat
605 fourth operation lever
605a, 605b base end, end
606 fifth operation lever
607 first operation mechanism (operation mechanism for work machine)
608 second operation mechanism (operation mechanism for work machine)
670 plate
671 support member
672, 673 first actuator, second actuator
674 first guide member (guide member)
674a, 674b front end (one end), rear end (the other end)
674c through hole
674d, 674e protrusion (positioning part)
675 first rotation member (support member)
675a bolt hole
675b concave portion
675c convex portion
676 bolt
677 second guide member (guide member)
677a, 677b left end (one end), right end (the other end)
678 second rotation member (support member)
679 bolt
681 base end
682 cover (bracket)

What is claimed is:

1. A remote driving device which manipulates an operation mechanism for a work machine based on an operation command signal, the remote driving device comprising:
an operation lever to control an operation amount of the work machine depending on a tilting angle and a tilting direction; and
a first operation mechanism which tilts the operation lever in a first direction, wherein the first operation mechanism comprises:
a first actuator which generates a driving force to tilt the operation lever in the first direction via a first-direction guide member based on the operation command signal;
a first transmission device which transmits the driving force generated by the first actuator to the first-direction guide member;
a first detector which detects a tilting amount of the operation lever to the first direction; and
a first drive shaft which rotates with the tilting of the operation lever to the first direction,
on the first drive shaft, a first rotation output part which transmits the rotation of the first drive shaft to the first detector is disposed, and
the first detector detects the tilting amount of the operation lever to the first direction via the first rotation output part.

2. The remote driving device according to claim 1, wherein a length of the first rotation output part in a direction of the first drive shaft is shorter than a length of the first rotation output part in the first drive shaft direction in a case where the first detector is disposed on the first drive shaft.

3. The remote driving device according to claim 1, wherein the first-direction guide member is pivotally supported so as to rotatable about the first drive shaft.

4. The remote driving device according to claim 1, wherein the first rotation output part includes a first transmission part extended from the first drive shaft toward the first detector, the first transmission part has an external shape with a first teeth portion formed on a circular arc around the first drive shaft, and
the first detector includes a first rotation part to be rotated by the first teeth portion and detects the rotation of the first rotation part to detect the tilting amount of the operation lever to the first direction.

5. The remote driving device according to claim 1, wherein the first actuator includes a first rotary shaft which generates a driving force to tilt the operation lever in a first direction, and the first rotary shaft is disposed parallel to and offset from the first drive shaft.

6. The remote driving device according to claim 1, further comprising:
a second operation mechanism which tilts the operation lever in a second direction that is a direction intersecting the first direction, wherein the second operation mechanism comprises:
a second-direction guide member which tilts the operation lever in the second direction,
a second actuator which generates a driving force to tilt the operation lever via the second-direction guide member based on the operation command signal,
a second transmission device which transmits the driving force generated by the second actuator to the second-direction guide member,
a second detector which detects a tilting amount of the operation lever to the second direction, and
a second drive shaft which rotates with the tilting of the operation lever to the second direction,
on the second drive shaft, a second rotation output part which transmits the rotation of the second drive shaft is disposed, and
the second detector detects the tilting amount of the operation lever to the second direction via the second rotation output part.

7. The remote driving device according to claim 6, wherein at least parts of the first transmission device and the second transmission device overlap, in a directional view perpendicular to a plane including the axis of the first drive shaft and the axis of the second drive shaft, or a directional view parallel to a straight line connecting the first drive shaft and the second drive shaft at the shortest distance.

8. The remote driving device according to claim 6, wherein a first connection part of the first transmission device to which the first actuator is connected and a second connection part of the second transmission device to which the second actuator is connected are both included in one of four regions defined by a vertically extending virtual plane including the axis of first drive shaft intersecting a vertically extending virtual plane including the axis of the second drive shaft.

9. An operation mechanism for a work machine, which tilts, in a first direction based on an operation command, an operation lever to control an operation of the work machine in response to being tilted in the first direction, the operation mechanism comprising:
an actuator to tilt the operation lever in the first direction based on the operation command;
a pair of guide members extending along the first direction from one end toward the other end to guide the operation lever, the guide members being provided facing each other to sandwich the operation lever between the guide members in a second direction perpendicular to the first direction;
a pair of support members to which the pair of guide members are respectively attached in the one end and the other end, respectively; and
a positioning part formed in the pair of support members, to position at least one of the one end and the other end of each of the pair of guide members in the second direction.

10. The operation mechanism for the work machine according to claim 9, wherein the positioning part is constituted of one or both of a concave portion and a convex portion formed in each support member in a third direction perpendicular to the first direction and the second direction and engages with at least a part of at least one of the one end and the other end of each of the pair of guide members.

11. The operation mechanism for the work machine according to claim 8, further comprising:
a bracket which covers at least a part of an outer circumference of the operation lever, the bracket being sandwiched between the pair of guide members.

12. A work machine comprising the operation mechanism for the work machine according to claim 9.
